(19) United States
(12) Patent Application Publication
(10) Pub. No.: US 2024/0161216 A1
(43) Pub. Date: May 16, 2024

(54) Method, System, and Computer Program Product for Efficiently Activating with Multiple Interacting Pipelines

(71) Applicant: Baptist Health South Florida, Inc., Coral Gables, FL (US)

(72) Inventor: George S. Godfrey, Miami Shores, FL (US)

(21) Appl. No.: 18/510,834

(22) Filed: Nov. 16, 2023

Related U.S. Application Data
(60) Provisional application No. 63/384,052, filed on Nov. 16, 2022.

(51) Int. Cl. G06Q 50/18; G06Q 10/0631

(52) U.S. Cl. CPC G06Q 50/18; G06Q 10/06315

(57) ABSTRACT

A method, system, and computer program product for automatically resolving match exceptions in a supply chain are disclosed, including providing a plurality of interacting pipelines for sourcing a concept to a contract, including a concept pipeline and a contract pipeline; initiating the concept pipeline to generate activities for guiding organizational users to determine sourcing details associated with an organizational opportunity or need; initiating the contract pipeline to generate activities capable of defining one or more terms, conditions, or legal requirements of the contract, for an acquisition of goods, services, or products related to the organizational opportunity or requirement; and synchronizing the plurality of interacting pipelines based on a trigger.

### CROSS-REFERENCE TO RELATED APPLICATION

This application claims the benefit of U.S. Provisional Patent Application No. 63/384,052, filed Nov. 16, 2022, the disclosure of which is hereby incorporated by reference in its entirety.

### BACKGROUND

### 1. Field

The disclosed subject matter relates generally to methods, systems, and computer program products for automatically activating with multiple interacting pipelines, a series of activities and steps included in the creation, distribution, and management of supply chain from source to end consumer, and in some embodiments or aspects, automated call-to-action activation for resolving each match exception. The disclosed subject matter relates generally to systems, methods, and computer program products for deploying a concept to contract in health care supply chain and, in some particular embodiments or aspects, to dynamic sourcing, scoping, approval, deployment, and approval of vendors.

### 2. Technical Considerations

Within an institution's operations, various enterprise computer systems are configured and deployed to manage the processing of goods, services, invoices, agreements, and other items received from customers, suppliers, service providers, and other entities. While some suppliers still send invoices in non-digital formats, necessitating manual entry by accounts payable (AP) professionals into their Enterprise Procurement Systems (EPS)/AP software, this manual process often results in transcription errors. Alternatively, some items are presented electronically, such as invoice images or other electronic forms. However, institutions employing different computer systems might use hardware and software tools to validate and process items leading to divergent results.

As new technologies find practical applications across various domains, organizations seek new solutions to tackle new and intricate business challenges. For instance, applications play a crucial role in generating essential information through activities such as record review, verification, segmentation, security checks, customer support, auditing, and record-keeping. While current EPS/Enterprise Resource Planning (ERP) systems excel at transaction creation and financial information capture, they are compromised when it comes to data management, visualization, and communication.

For example, supply chain systems heavily rely on EPS or ERP systems to manage administrative tasks. However, these systems often fall short in efficiently addressing issues and determining necessary actions due to their inability to effectively process and communicate the multitude of data points. Additionally, such critical systems lack the capacity to seamlessly implement solutions for observed issues without significant manual intervention.

### SUMMARY

Accordingly, it is an object of the presently disclosed subject matter to provide methods, systems, and computer program products for efficiently activating with multiple interacting pipelines that overcome some or all of the deficiencies identified above.

According to non-limiting embodiments or aspects, provided is a computer-implemented method, comprising: a computer-implemented method, comprising: providing a plurality of interacting pipelines for sourcing a concept to a contract, including a concept pipeline and a contract pipeline; initiating the concept pipeline to generate activities for guiding organizational users to determine sourcing details associated with an organizational opportunity or need; initiating the contract pipeline to generate activities capable of defining one or more terms, conditions, or legal requirements of the contract, for an acquisition of goods, services, or products related to the organizational opportunity or requirement; and synchronizing the plurality of interacting pipelines based on a trigger.

According to non-limiting embodiments or aspects, provided is a system, comprising: a system, comprising: a memory; and at least one processor coupled to the memory and configured to: provide a plurality of interacting pipelines for sourcing a concept to a contract, including a concept pipeline and a contract pipeline; initiate the concept pipeline to generate activities for guiding organizational users to determine sourcing details associated with an organizational opportunity or need; initiate the contract pipeline to generate activities capable of defining one or more terms, conditions, or legal requirements of the contract, for an acquisition of goods, services, or products related to the organizational opportunity or requirement; and synchronize the plurality of interacting pipelines based on a trigger.

According to non-limiting embodiments or aspects, provided is a non-transitory computer-readable medium having instructions stored thereon that, when executed by at least one computing device, cause the at least one computing device to: . . . Clause 18: A non-transitory computer-readable medium having instructions stored thereon that, when executed by at least one computing device, cause the at least one computing device to: provide a plurality of interacting pipelines for sourcing a concept to a contract, including a concept pipeline and a contract pipeline; initiate the concept pipeline to generate activities for guiding organizational users to determine sourcing details associated with an organizational opportunity or need; initiate the contract pipeline to generate activities capable of defining one or more terms, conditions, or legal requirements of the contract, for an acquisition of goods, services, or products related to the organizational opportunity or requirement; and synchronize the plurality of interacting pipelines based on a trigger.

Further non-limiting embodiments or aspects are set forth in the following numbered clauses:

Clause 1: a computer-implemented method, comprising: providing a plurality of interacting pipelines for sourcing a concept to a contract, including a concept pipeline and a contract pipeline; initiating the concept pipeline to generate activities for guiding organizational users to determine sourcing details associated with an organizational opportunity or need; initiating the contract pipeline to generate activities capable of defining one or more terms, conditions, or legal requirements of the contract, for an acquisition of goods, services, or products related to the organizational opportunity or requirement; and synchronizing the plurality of interacting pipelines based on a trigger.

Clause 2: The computer-implemented clause of clause 1, wherein synchronizing the plurality of interacting pipelines based on the trigger further comprises: detecting the trigger; in response to the trigger, activating a signal to initiate one or more activities in the contract pipeline; or in response to the trigger, activating a signal to initiate one or more activities in the contract pipeline.

Clause 3: The computer-implemented method of clauses 1-2, wherein the trigger occurs at a stage in the concept pipeline to ensure that activities associated with development of the concept align with development of contract terms or requirements, and includes at least one of: a transition trigger, wherein the concept progresses to a point where a formal contract is needed to formalize an agreement between parties; an awards trigger, wherein one or more vendors are awarded the contract; a decision trigger, wherein a sourcing decision is generated; a contract trigger, wherein it is determined that a formal contract is necessary; or a communication trigger, wherein synchronization between the plurality of interacting pipelines includes communication of one or more critical details, requirements, or information related to a procurement decision, a selected vendor, one or more terms, or one or more conditions.

Clause 4: The computer-implemented method of clauses 1-3, wherein information gathered by the concept pipeline, includes at least one of supplier evaluations, vendor selections, or procurement requirements, is transferred to the contract pipeline for drafting and negotiation.

Clause 5: The computer-implemented method of clauses 1-4, wherein the concept pipeline and the contract pipeline run concurrently while at least one activation is made between the interacting pipelines to expedite a procurement.

Clause 6: The computer-implemented method of clauses 1-5, wherein at least one activation is made between the interacting pipelines to expedite a procurement comprising at least one of: identifying a need for a conceptual product or service; creating a request for the conceptual product or service; or obtaining one or more approvals that are required within the concept pipeline; and wherein the contract pipeline comprises: approving a requisition, contract drafting, or contract award.

Clause 7: The computer-implemented method of clauses 1-6, further comprising: providing a concept to contract (C2C) prediction engine for generating scores; scoring, by the C2C prediction engine, one or more concepts as part of an assessment process to streamline decision-making and provide a quantitative measurement of the concept; and prioritizing the one or more concepts based on a score for at least one of a viability of a concept, an alignment of a concept with at least one organizational goal, or a potential impact of a concept, and each score provides a quantitative measure to compare different concepts and to guide decision-makers in selecting a concept to proceed.

Clause 8: The computer-implemented method of clauses 1-7, further comprising: obtaining a set of evaluation criteria and key performance indicators (KPIs) that align with one or more objectives related to factors like cost-effectiveness, strategic alignment, feasibility, and potential impact; assigning each criterion from the set of evaluation criteria a weight to reflect its relative importance, wherein financial viability might be weighted more heavily than other criteria and a scores weighting reflects a priority to the at least one organization goal; assessing one or more concepts against each criterion; assigning a plurality of numerical scores related to an alignment of the concept for each criterion; normalizing the plurality of numerical scores to ensure that different criterion are on a common scale; and generating a total concept score comprising each of the plurality of numerical scores to quantify an overall quality of the concept.

Clause 9: The computer-implemented method of clauses 1-8, wherein each score reduces bias and subjectivity assessing one or more concepts against each criterion by providing an objective basis for comparing different ideas or proposals related to each concept, wherein the total concept score allows decision-makers to prioritize concepts with higher scores are considered more promising and can be fast-tracked for further development, wherein resources are directed to concepts with a greatest potential for success to prevent resources to limit over allocation of resource, wherein concepts are evaluated against predefined criteria to identify potential risks and challenges and take appropriate actions to mitigate these risks or select alternative concepts, wherein a scoring process ensures that selected concepts align with an organization's strategic goals and priorities; wherein concepts that score high move through the plurality of the interacting pipelines more quickly than those that score lower for a streamlined execution of initiatives; and wherein a scoring system provides transparency to stakeholders, providing insight into certain concepts that are chosen or rejected to enhance buy-in or support for selected concepts.

Clause 10: A system, comprising: a memory; and at least one processor coupled to the memory and configured to: provide a plurality of interacting pipelines for sourcing a concept to a contract, including a concept pipeline and a contract pipeline; initiate the concept pipeline to generate activities for guiding organizational users to determine sourcing details associated with an organizational opportunity or need; initiate the contract pipeline to generate activities capable of defining one or more terms, conditions, or legal requirements of the contract, for an acquisition of goods, services, or products related to the organizational opportunity or requirement; and synchronize the plurality of interacting pipelines based on a trigger.

Clause 11: a system of clause 10, wherein synchronizing the plurality of interacting pipelines based on the trigger further comprises configuring the at least one processor to: detecting a trigger; in response to the trigger, activating a signal to initiate one or more activities in the contract pipeline; or in response to the trigger, activating a signal to initiate one or more activities in the contract pipeline.

Clause 12: The system of clauses 10-11, wherein the trigger occurs at a stage in the concept pipeline to ensure that activities associated with development of the concept align with development of contract terms or requirements, and includes at least one of: a transition trigger, wherein the concept progresses to a point where a formal contract is needed to formalize an agreement between parties; an awards trigger, wherein one or more vendors are awarded the contract; a decision trigger, wherein a sourcing decision is generated; a contract trigger, wherein it is determined that a formal contract is necessary; or a communication trigger, wherein synchronization between the plurality of interacting pipelines includes communication of one or more critical details, requirements, or information related to a procurement decision, a selected vendor, one or more terms, or one or more conditions.

Clause 13: The system of clauses 10-12, wherein information gathered by the concept pipeline, includes at least one of supplier evaluations, vendor selections, or procurement requirements, is transferred to the contract pipeline for drafting and negotiation.

Clause 14: The system of clauses 10-13, wherein the concept pipeline and the contract pipeline run concurrently while at least one activation is made between the interacting pipelines to expedite a procurement.

Clause 15: The system of clauses 10-14, wherein at least one activation is made between the interacting pipelines to expedite a procurement comprising at least one of: identifying a need for a conceptual product or service; creating a request for the conceptual product or service; or obtaining one or more approvals that are required within the concept pipeline; and wherein the contract pipeline comprises: approving a requisition, contract drafting, or contract award.

Clause 16: The system of clauses 10-15, wherein the at least one processor to is configured to: providing a concept to contract (C2C) prediction engine for generating scores; scoring, by the C2C prediction engine, one or more concepts as part of an assessment process to streamline decision-making and provide a quantitative measurement of the concept; and prioritizing the one or more concepts based on a score for at least one of a viability of a concept, an alignment of a concept with at least one organizational goal, or a potential impact of a concept, and each score provides a quantitative measure to compare different concepts and to guide decision-makers in selecting a concept to proceed.

Clause 17: The system of clauses 10-16 wherein the at least one processor is configured to: obtaining a set of evaluation criteria and key performance indicators (KPIs) that align with one or more objectives related to factors like cost-effectiveness, strategic alignment, feasibility, and potential impact; assigning each criterion from the set of evaluation criteria a weight to reflect its relative importance, wherein financial viability might be weighted more heavily than other criteria and a scores weighting reflects a priority to the at least one organization goal; assessing one or more concepts against each criterion; assigning a plurality of numerical scores related to an alignment of the concept for each criterion; normalizing the plurality of numerical scores to ensure that different criterion are on a common scale; and generating a total concept score comprising each of the plurality of numerical scores to quantify an overall quality of the concept, wherein each score reduces bias and subjectivity assessing one or more concepts against each criterion by providing an objective basis for comparing different ideas or proposals related to each concept, wherein the total concept score allows decision-makers to prioritize concepts with higher scores are considered more promising and can be fast-tracked for further development, wherein resources are directed to concepts with a greatest potential for success to prevent resources to limit over allocation of resource, wherein concepts are evaluated against predefined criteria to identify potential risks and challenges and take appropriate actions to mitigate these risks or select alternative concepts, wherein a scoring process ensures that selected concepts align with an organization's strategic goals and priorities; wherein concepts that score high move through the plurality of the interacting pipelines more quickly than those that score lower for a streamlined execution of initiatives; and wherein a scoring system provides transparency to stakeholders, providing insight into certain concepts that are chosen or rejected to enhance buy-in or support for selected concepts.

Clause 18: A non-transitory computer-readable medium having instructions stored thereon that, when executed by at least one computing device, cause the at least one computing device to: provide a plurality of interacting pipelines for sourcing a concept to a contract, including a concept pipeline and a contract pipeline; initiate the concept pipeline to generate activities for guiding organizational users to determine sourcing details associated with an organizational opportunity or need; initiate the contract pipeline to generate activities capable of defining one or more terms, conditions, or legal requirements of the contract, for an acquisition of goods, services, or products related to the organizational opportunity or requirement; and synchronize the plurality of interacting pipelines based on a trigger.

Clause 19: The non-transitory computer-readable medium of clause 18 wherein diagnosing at least one match exception, further causes the at least one computing device to: detect a trigger; in response to the trigger, activating a signal to initiate one or more activities in the contract pipeline; or in response to the trigger, activating a signal to initiate one or more activities in the contract pipeline.

Clause 20: The non-transitory computer-readable medium of clauses 18-19, wherein diagnosing at least one match exception, further includes: a transition trigger, wherein the concept progresses to a point where a formal contract is needed to formalize an agreement between the parties; an awards trigger, wherein one or more vendors are awarded the contract; a decision trigger, wherein a sourcing decision is generated; a contract trigger, wherein it is determined that a formal contract is necessary; or a communication trigger, wherein synchronization between the plurality of interacting pipelines includes communication of one or more critical details, requirements, or information related to a procurement decision, a selected vendor, one or more terms, or one or more conditions.

Accordingly, it is an object of the presently disclosed subject matter to provide methods, systems, and computer program products for efficiently activating with multiple interacting pipelines that overcome some or all of the deficiencies identified above.

These and other features and characteristics of the presently disclosed subject matter, as well as the methods of operation and functions of the related elements of structures and the combination of parts and economies of manufacture, will become more apparent upon consideration of the following description and the appended claims with reference to the accompanying drawings, all of which form a part of this specification, wherein such as reference numerals designate corresponding parts in the various figures. It is to be expressly understood, however, that the drawings are for the purpose of illustration and description only and are not intended as a definition of the limits of the disclosed subject matter. As used in the specification and the claims, the singular form of “a,” “an,” and “the” include plural referents unless the context clearly dictates otherwise.

### BRIEF DESCRIPTION OF THE DRAWINGS

Additional advantages and details of the disclosed subject matter are explained in greater detail below with reference to the exemplary embodiments that are illustrated in the accompanying figures, in which:

FIG. 1 is a diagram of a non-limiting embodiment of an environment in which methods, systems, and/or computer program products for efficiently activating with multiple interacting pipelines, described herein, which may be implemented according to the principles of the presently disclosed subject matter;

FIG. 2 is a flow diagram of a non-limiting embodiment for efficiently activating with multiple interacting pipelines;

FIG. 3 is a step diagram for a method of efficient activations with multiple interacting pipelines in a supply chain;

FIG. 4 is a diagram of a non-limiting embodiment of an environment in which methods, systems, and/or computer program products, described herein, may be implemented according to the principles of the presently disclosed subject matter;

FIG. 5 illustrates example components of a device used in connection with non-limiting embodiments; and

FIGS. 6A-6E are exemplary call-to-action illustrations for communicating match exceptions in a supply chain according to non-limiting embodiments.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting unless otherwise indicated.

No aspect, component, element, structure, act, step, function, instruction, and/or like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or like) and may be used interchangeably with “one or more” or “at least one.” Where only one item is intended, the term “one” or similar language is used. Also, as used herein, the terms “has,” “have,” “having,” or like are intended to be open-ended terms. Further, the phrase “based on” is intended to mean “based at least partially on” unless explicitly stated otherwise.

As used herein, satisfying a threshold may refer to a value (e.g., a score, a power consumption, etc.) being greater than the threshold, more than the threshold, higher than the threshold, greater than or equal to the threshold, less than the threshold, fewer than the threshold, lower than the threshold, less than or equal to the threshold, equal to the threshold, etc.

As used herein, the terms “communication” and “communicate” may refer to the reception, receipt, transmission, transfer, provision, and/or like of information (e.g., data, signals, messages, instructions, commands, and/or like). For one unit (e.g., a device, a system, a component of a device or system, combinations thereof, and/or like) to be in communication with another unit means that the one unit is able to directly or indirectly receive information from and/or transmit information to the other unit. This may refer to a direct or indirect connection (e.g., a direct communication connection, an indirect communication connection, and/or like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or like) that includes data. It will be appreciated that numerous other arrangements are possible.

As used herein, the terms “client” and “client device” may refer to one or more client-side devices or systems (e.g., remote from a service or healthcare provider) used to handle a match exception (e.g., a transaction, action, or communication in association with a call to action or other activity associated with a match exception). As an example, a “client device” may refer to one or more devices used by a vendor or supplier, one or more host computers used by a supplier or vendor, one or more mobile devices used by a user, and/or like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, PDAs, and/or like). Moreover, a “client” may also refer to an entity (e.g., a vendor, a supplier, and/or like) that owns, utilizes, and/or operates a client device for transactions (e.g., for transactions within a supply chain).

As used herein, the term “computing device” may refer to one or more electronic devices configured to process data. A computing device may, in some examples, include the necessary components to receive, process, and output data, such as a processor, a display, a memory, an input device, a network interface, and/or like. A computing device may be a client device or a mobile device. As an example, a mobile device may include a cellular phone (e.g., a smartphone, standard cellular phone, etc.), a portable computer, a wearable device (e.g., watches, glasses, lenses, clothing, and/or like), a personal digital assistant (PDA), and/or other such as devices. A computing device may also be a desktop computer or other form of non-mobile computer.

As used herein, the term “server” may refer to one or more computing devices (e.g., processors, storage devices, similar computer components, and/or like) that communicate with client devices and/or other computing devices over a network (e.g., a public network, the Internet, a private network, and/or like) and, in some examples, facilitate communication among other servers and/or client devices. It will be appreciated that various other arrangements are possible. As used herein, the term “system” may refer to one or more computing devices or combinations of computing devices (e.g., processors, servers, client devices, software applications, components of such, and/or like). Reference to “a device,” “a server,” “a processor,” and/or like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

As used herein, the terms “ERP” or “enterprise resource planning” is systems and software designed to manage and integrate the functions of core business processes such as finance, HR, supply chain and inventory management in a single system, including software components (e.g., interfaces, independent software deployments, etc.), each of which focuses on a distinct process, including the ERP finance component which automates basic accounting, invoicing, healthcare analysis, forecasting and reporting, into a single ERP system to manage all of the healthcare transactions and accounting for multiple healthcare units, suppliers, or patients, other ERP components include order management, customer relationship management (CRM), purchasing (e.g., procurement), and human resources (HR) to handle employee records, benefits management and payroll.

As used herein, the term “supervised learning” may refer to one or more machine learning algorithms that start with known input variables (x) and an output variable (y), and learn the mapping function from the input to the output. The goal of supervised learning is to approximate the mapping function so that predictions can be made about new input variables (x) that can be used to predict the output variables (y) for that data. The process of a supervised algorithm learning from the training dataset can be thought of as a teacher supervising the learning process. The correct answers are known. The algorithm iteratively makes predictions on the training data and is corrected by the teacher. Learning stops when the algorithm achieves an acceptable level of performance. Supervised learning problems can be further grouped into regression problems and classification problems. Supervised learning techniques can use labeled (e.g., classified) training data with normal and outlier data, but are not as reliable because of the lack of labeled outlier data. For example, multivariate probability distribution based systems are likely to score the data points with lower probabilities as outliers. A regression problem is when the output variable is a real value, such as “dollars” or “exceptions”.

An exemplary regression problem includes predicting a contract renewal date to predict a numerical value based on historical data. For example, predicting the exact renewal date for a contract based on various features, such as contract history, supplier performance, and market conditions based on historical contract data, supplier performance metrics, market data, contract details, and/or the like, to generate a numerical value representing the predicted renewal date. For example, regression algorithms like linear regression, decision trees, or random forest regression are generated to make predictions about historical data and identify patterns to forecast the renewal date more accurately. An exemplary classification problem sorts the output variables into a category, such as “red” and “blue,” or “compliant” and “non-compliant”. Such a classification problem includes categorizing purchase requisitions to assign a data point to a specific category or class. For example, categorizing purchase requisitions into groups like “urgent,” “standard,” or “low priority” based on their critical parameters, supplier performance, and internal requirements to predict details of purchase requisitions, critical parameters, supplier performance scores, internal requirements, and/or the like. A category label (e.g., “urgent,” “standard,” “low priority”, etc.) may be predicted for each purchase requisition. Classification algorithms like logistic regression, decision trees, or support vector machines can be used by learning from historical data to classify new purchase requisitions into the appropriate category based on features and attributes. Improved precise predictions and categorizations, aid in sourcing, requisitions, and overall procurement efficiency.

As used herein, the term “unsupervised learning” may refer to an algorithm which has input variables (x) and no corresponding output variables. The goal for unsupervised learning is to model the underlying structure or distribution in the data in order to learn more about the data. Unlike supervised learning, in unsupervised learning there are no correct answers and there is no teacher. Unsupervised learning algorithms are used to discover and present the interesting structure in the data. Unsupervised learning problems can be further grouped into clustering and association problems. A clustering problem is modeling used to discover the inherent groupings in a dataset, such as grouping customers by purchasing behavior. An association rule learning problem may be used to discover rules that describe large portions of data, such as supplier performance rules to discover rules that link supplier performance metrics (e.g., on-time delivery, quality, responsiveness, etc.) to contract renewal or termination decisions (e.g., when supplier performance rating is ‘excellent’ and contract is expiring in 90 days, then initiate contract renewal, etc.), cost savings association rules to identify rules that define conditions under which cost-saving opportunities are recognized (e.g., when historical cost savings exceed 10% for a specific supplier and contract, initiate a price negotiation, etc.), inventory management rules to determine rules that optimize inventory levels (e.g., when inventory level reaches the trigger point and there are open purchase requisitions for the item, automatically generate a purchase order, etc.), and/or the like. Some examples of unsupervised learning algorithms are clustering and likelihood modeling.

As used herein, the term “training” may refer to a process of analyzing training data to generate a model (e.g., create a machine learning algorithm, a prediction model, a classification model, a segmentation model, etc.). For example, a training server uses machine learning techniques to analyze the training data to generate the model, often the training data includes numerous examples so that a robust model is generated to solve a problem for many variations present in the data. In some non-limiting embodiments or aspects, generating the model (e.g., based on training data from a variety of sources) is referred to as “training the model.” The machine learning techniques include, for example, supervised and/or unsupervised techniques, such as decision trees (e.g., gradient boosted decision trees), logistic regressions, artificial neural networks (e.g., convolutional neural networks), Bayesian statistics, learning automata, hidden Markov modeling, linear classifiers, quadratic classifiers, association rule learning, and/or like. In some examples, the model includes a prediction model that is specific to a particular geographic location, a particular supplier, a particular vendor, and/or like. Such as decision trees for predicting the most effective negotiation strategies for contract terms with a particular supplier sourcing process, logistic regression estimating the likelihood of a contract exception occurring during the review and approval of terms and conditions, artificial neural networks learning patterns in historical contract documents to identify new patterns and best practices for contract creation and management, Bayesian statistics for determining the probability of delays or bottlenecks in the concept to contract (C2C) steps based on historical data and external factors, like regulatory changes, hidden Markov modeling predicting the expected timeline for moving from the concept stage to the contract stage for a specific type of procurement, linear classifiers estimating the likelihood of a specific concept progressing to the contract stage based on criteria such as cost, feasibility, and strategic importance, quadratic classifiers predicting the potential cost savings associated with a specific contract based on historical procurement data. Association rule learning associations between different concepts and their respective contract outcomes to optimize decision-making and resource allocation. Additionally, or alternatively, the prediction model may be specific to a particular user or thing (e.g., a supplier of a healthcare facility that uses medical devices, a pharmaceutical supplier, a supplier extending a voucher price, one or more receipts for a purchase order, receipts for a purchase order specified on a voucher, etc.). In other examples, a training server generates one or more prediction models (e.g., one or more C2C models, one or more purchase order segmentations, one or more voucher classifications, etc.) for one or more accounts (e.g., one or more supplier accounts, one or more vendor accounts, etc.), a particular group of customers, and/or like.

As used herein, the term “machine learning inference engine” may refer to a process of executing a model algorithm and returns an inference output. For example, an inference engine (e.g., inference server, etc.) may utilize one or more processing units (e.g., a central processing unit (CPU), general processing unit (GPU), tensor processing unit (TPU), field programmable gateway array (FPGA), an application-specific integrated circuit (ASIC), etc.) to execute the model algorithm. In some non-limiting embodiments or aspects, a processing choice for machine learning inference can have a significant impact on speed, throughput, latency, accuracy, rate of learning, energy efficiency, and rate of learning.

As used herein, the term “interactive” may refer to the dynamic and interconnected nature of multiple structures, for example, at the various stages of multiple pipelines, such that, different stages or processes may occur simultaneously or interact with each other in a coordinated manner. Interactive may include concurrent processes, for example, multiple stages of the concept-to-contract lifecycle can occur concurrently. For example, while negotiations are ongoing for a contract, a sourcing process for the contract (e.g., or another contract, etc.) may be in progress. In some examples, interactive may include parallelism, for example processing simultaneously to hasten the overall timeline of the concept-to-contract workflow. Interactive pipelines may involve information generated or decisions made in one stage that can influence or be utilized by other stages. For example, insights gained during the sourcing phase might impact the negotiation strategy, and feedback from contract reviews and could lead to adjustments in the sourcing approach. This interconnectedness ensures that the pipeline operates cohesively, for example, involving real-time collaboration among stakeholders involved in different stages, legal teams providing immediate feedback during contract drafting, procurement teams collaborating with sourcing teams, or for making decisions at different stages, such as review of contract terms, negotiations on pricing or other terms that may continue simultaneously.

As used herein, the term “pipeline” may refer to a system or process that involves a series of connected stages or steps through which something (such as information, materials, or products) passes. A pipeline may refer to a set of processes for communicating information or data from one place to another (e.g., the automated flow of information from source systems to destination systems, through a structured and interconnected series of processes or stages that facilitate the progression of activities from the initial concept or idea through the various steps leading to the final contract formation. A pipeline may encompass an entire lifecycle of activities involved in transforming a conceptualized need or opportunity into a concrete contractual agreement, or discrete pieces of a lifecycle, such that each stage within the pipeline represents a distinct phase in the C2C process, where the flow is typically designed to be systematic, efficient, and goal-oriented. For example, in the C2C pipeline, you might have stages such as: conceptualization (e.g., the initial ideas or needs identified and defined based on requirements and scoping of the potential contracts, sourcing (e.g., identifying potential suppliers or partners along with market analysis, supplier evaluation, and proposal requests, etc.), negotiation (e.g., discussions on terms, conditions, pricing, and other relevant aspects of the contract, etc.), contract formation (e.g., drafting formal contract documents specifying the terms and conditions, deliverables, timelines, other contractual details, etc.), review and approval (e.g., review by legal and other relevant departments and approvals from stakeholders are obtained to proceed with the contract, etc.), execution (e.g., signing and executing by the involved parties to mark the formal commencement of the contractual relationship, etc.), monitoring and management (e.g., monitoring performance, managing potential issues, ensuring compliance with the agreed-upon terms, and/or the like), closure (e.g., the end of a contract term or its objectives are fulfilled, closing may include evaluations, renewals, or transitioning to new contracts.

As used herein, the term “operating parameters” refers to the predefined and adjustable settings or conditions within the C2C system that dictate how the system functions, such operating parameters may include specific rules, thresholds, criterion, and/or the like, which guide the automated processes, workflows, and activations within the system. Adjusting these operating parameters allows for customization and optimization of the C2C processes based on the unique needs and requirements of the organization.

As used herein, the term “critical parameters” refers to parameters that hold significant importance due to their direct impact on the efficiency, accuracy, and effectiveness of the C2C system. Critical parameters are crucial for the proper functioning and effectiveness of the system. Adjusting critical parameters may have a substantial influence on organizational goals, how the system identifies, communicates, resolves issues within the contract management processes, and/or the like. Managing and configuring critical parameters to provide optimal performance and outcomes for C2C activities.

As used herein, the term “call-to-action” may refer to a specific configuration, programming instruction, software element, or prompt provided to a user (e.g., a vendor, a supplier, an employee, staff member, etc.), such that the user is called (e.g., informed, notified, prompted, etc.) to take a particular action to address or resolve a specific exception, issue, condition, or other item identified within a program or system, or a directive (e.g., notification, alert, message, etc.) to address an exceptional situation effectively, and in some non-limiting embodiments or aspects, requires human intervention of a program or system with a problem or issue therein. For example, when an exception is detected or an issue arises, a call-to-action may be used to alert, warn, or notify a user to take an action to address a problem or issue, or escalate a problem previously identified in a call-to-action to cause relevant personnel to be notified about a need to address the issue. The call-to-action prompts the individual to respond and take appropriate steps to resolve the problem, correct data discrepancies, and perform necessary tasks to safeguard operations within the supply chain or other processes.

As used herein, the term “diagnosis” refers to the capability of analyzing and comprehensively assessing the operating parameters of a resource planning system, a database, a data visualization, and/or like. For example, this may entail a dynamic process of determining the multifaceted operating parameters of the resource planning system, comparing with critical and context-specific parameters necessary for the effective control and management of the supplier management system (e.g., the supply chain system, supplier sales automation system, etc.), or other related integrated systems. This correlation is achieved through analysis, matching, and rigorous checking of one or more data elements, data structures, or states of data elements, and/or the like, such analyses conducted within the distinct context of procurement or invoicing activities, such that the crux of the power to diagnose lies in the software's prowess to methodically scrutinize and evaluate the operating parameters of the resource planning system, and then extending the evaluation to detecting subtle nuances and intricate patterns that might otherwise go unnoticed. Thereby harnessing analytical capabilities embedded within the software to unveil issues, anomalies, or complexities embedded within the system that have the potential to reverberate throughout the supply chain and impede the seamless flow of procurement processes. The overarching objective of this multifaceted analysis is not only to pinpoint discrepancies and irregularities but also to initiate proactive measures. By proactively addressing these identified issues, the ‘power to diagnose’ contributes to the fortification of the supplier chain's integrity (e.g., one or more systems or processes of the supply chain, etc.) and the enhancement of the overall supply chain's resilience, wherein software-driven inferences empower organizations to preemptively mitigate disruptions, optimize operational efficiencies, and safeguards the uninterrupted flow of procurement activities. The problem that the diagnosis aims to address is the effective management and optimization of the supply chain and procurement activities. By diagnosing the operating parameters and correlating them with critical parameters, potential exceptions, inefficiencies, or deviations from expected performance, issues or possible issues such as delayed orders, incorrect pricing, discrepancies in supply and demand, other irregularities that may disrupt the supply chain or procurement workflow, and may be avoided or corrected. Corrective action may involve initiating the creation of new purchase orders, reordering items, balancing transaction costs back to the suppliers, restocking inventory, or recalling defective products. The match exception engine may also trigger automated responses or escalations to relevant personnel or systems to resolve the identified problems and prevent any adverse impacts on the supply chain or procurement processes.

As used herein, the term “supply chain” refers to the series of activities and steps involved in the creation, production, distribution, and management of goods and services from their source to the end consumer. These processes encompass various stages, such as procurement, manufacturing, transportation, distribution, and ultimately delivering products to customers. In the context of C2C, supply chain processes specifically relate to how healthcare providers manage the flow of materials, equipment, and services needed to support patient care within a healthcare setting. These processes involve activities such as procurement, inventory management, demand forecasting, supplier relationships, logistics, and/or the like. The goal of effective supply chain management is to safeguard that the right products and services are available at the right time, in the right quantity, and at the right cost. In addition, supply chain refers to the interconnected network of organizations, individuals, activities, information, resources, and technologies involved in the creation, production, distribution, and delivery of goods or services to end consumers. It may encompasses a product or service from its raw material stage through various stages of processing, manufacturing, transportation, storage, and ultimately reaching the end user. Supply chains can be complex, involving suppliers, manufacturers, distributors, retailers, and various intermediaries, all collaborating to safeguard that products or services are efficiently produced, transported, and made available to customers in a timely and cost-effective manner. Further, the term “healthcare supply chain” may refer more specifically to monitoring and supporting the flow of medicines, medical supplies and equipment, and medical services from manufacturer to patient, including supply chain quality management and planning, supply chain automation and optimization, and supplier relationship and risk management. “Healthcare supply chain system” may refer to digital tools and technology to carry out healthcare supply chain management, and may involve using actionable inferences obtained from multi-sourced data to continuously adjust and optimize supply chain systems and processes. As used herein, the supply chain framework (e.g., supply chain network, etc.) refers to the structured approach and systematic arrangement of processes, activities, entities, and technologies involved in the production, distribution, and delivery of goods or services from suppliers to consumers. The supply chain framework includes the entire supply chain (e.g., a chain of activity that bridges multiple entities for providing products or services, etc.) from raw material acquisition through production, distribution, and ultimately to deliverables for users (e.g., the end-users, customers, etc.). The supply chain framework is optimized for efficiency, to minimize costs, to enhance collaboration, and for timely delivery. Moreover, key components of a typical supply chain framework include suppliers (e.g., One or more entities or companies that provide the raw materials, components, or services needed for production, etc.), manufacturing/production (e.g., one or more phases for transforming raw materials into finished products through various processes, etc.), distribution and logistics (e.g., movement of products from manufacturing facilities to distribution centers, warehouses, retailers, consumers, etc.), including transportation, inventory management, and order fulfillment, retailers/wholesalers (e.g., intermediaries that store and sell products to consumers or other businesses, etc.), consumers (e.g., one or more end-users or final recipients of the products or services, etc.), technology and information system (e.g., advanced technologies, software, and information systems play a crucial role in tracking and managing various aspects of the supply chain, from inventory levels to demand forecasting, communication and collaboration (e.g., communication and collaboration among all stakeholders in the supply chain for operations and timely decision-making, etc.), risk management (e.g., assessing and managing risks associated with disruptions, etc.) of supply shortages, transportation delays, and/or the like for maintaining a supply chain, sustainability and ethics (e.g., modern supply chain frameworks with sustainability practices, including ethical sourcing, environmental considerations, and social responsibility, etc.), data analytics and optimization (e.g., identifying data collected throughout the supply chain to optimize processes, improve efficiency, enhance customer satisfaction, etc.). In some non-limiting embodiments or aspects, the supply chain framework aims to create a seamless flow of goods and services while minimizing costs, reducing waste, and responding effectively to changing market conditions.

As used herein, the term “Activation” refers to the initiation or triggering of a specific process or action within the procurement prediction engine 102 or the broader supplier management system. Including triggering of the commencement of a predefined sequence of operations based on certain conditions, events, or criteria being met. In this context, activation signifies the beginning of the automated steps or procedures executed by the procurement prediction engine 102 to respond to various situations related to supplier management, purchasing, supplier interactions, contract management, exception management, or item management. As used herein, “to activate” refers to setting in motion or starting the predefined sequence of actions within a procurement prediction engine 102 or supplier management system. This may involve triggering a specific response or series of operations within the system based on identified criteria or events. Activation involves the initiation of automated processes, such as sending notifications, requesting approvals, escalating responses, or generating follow-up actions, to address issues or progress through the stages of supplier-related tasks or procurement workflows.

As used herein, the term a “concept” refers to the initial idea, need, or requirement within an organization that may lead to the creation of a procurement or purchasing agreement. It's the starting point for a process that eventually results in a formal contract. The C2C process includes various stages, including the development of the idea or concept, its evaluation, strategic planning, negotiation, and ultimately the creation and management of the contract itself. The concept is the first step in this procurement lifecycle.

As used herein, the term a “match exception” refers to cases within the supply chain system where there is a discrepancy (e.g., inaccuracy, misalignment, etc.) between different sets of data or information that are expected to match or correspond. These discrepancies may involve various elements, such as purchase orders (e.g., requisitions, procurement orders, acquisition requests, etc.), invoices (e.g., bills, statements, payment requests, invoices, etc.), payment amounts (e.g., transaction values, billing amounts, monetary figures, etc.), vouchers (e.g., coupons, tokens, certificates, credits, etc.), costs (e.g., expenses, expenditures, outlays, charges, etc.), other related transactional details (e.g., additional relevant transaction information, associated financial particulars, etc.). As an example, match exception refers to a difference between the information presented in an invoice and the corresponding purchase order(s). For example, if a purchase order indicates a certain cost for a healthcare product, but the associated invoice specifies a different payment amount, it may result in a match exception. Similarly, discrepancies between different purchase orders for the same item could also trigger match exceptions. Further examples are discussed below. A match exception in this context signifies a divergence or inconsistency between expected and actual data values, particularly related to purchase orders, invoices, and payments, which the procurement prediction engine disclosed herein aims to predict and address for improved efficiency and accuracy in supply chain operations.

As used herein, the term a “contract renewal” refers to refers to the process of extending or continuing an existing contractual agreement between two or more parties after its initial term has expired. During a contract renewal, the parties involved typically review the terms and conditions of the existing contract, negotiate any necessary changes or updates, and then formally agree to extend the contract for a specified period. Contract renewals are common in various business contexts, including vendor agreements, service contracts, lease agreements, and more.

As used herein, the term a “contract maintenance” refers to the ongoing management and oversight of an existing contract throughout its active term. This ongoing management and oversight of an existing contract includes activities such as monitoring compliance with contract terms, tracking performance metrics, ensuring that obligations are met by all parties, addressing any issues or disputes that may arise during the contract's lifecycle, and/or the like. Effective contract maintenance helps to safeguard the interests of the parties involved and ensures that the contract remains in force and productive.

As used herein, the term a “requisition placement” refers to the act of formally requesting and initiating the procurement or purchase of goods, services, or materials within an organization (e.g., placing a requisition). A requisition is a document or request that specifies the details of what is needed, such as the quantity, description, quality, other relevant information, and/or the like. Requisition placement is typically the first step in the procurement process, and it may trigger subsequent actions, including approval workflows, purchasing orders, internal activities, supplier communication, and/or the like to fulfill the requested items or services for efficient procurement and inventory management.

The methods and systems described herein relate to healthcare supply chains, but may also apply to a wide range of other industries and supply chains as well. Some examples include pharmaceuticals, similar to healthcare pharmaceutical supply chains deal with the distribution of medications and may help in tracking and authenticating pharmaceuticals, predicting demand, and ensuring compliance with regulations. Retail, where products are sourced, managed, and distributed through various channels. The system could help in managing inventory, predicting demand, optimizing logistics, and enhancing communication with suppliers. Manufacturing, where raw materials, production processes, and distribution of finished goods help in predicting maintenance needs, optimizing production schedules, and ensuring efficient utilization of resources. Automotive, which includes complex networks of suppliers providing components for vehicle assembly help in predicting component shortages, optimizing production to meet demand, and improving collaboration with suppliers. Electronics, which includes the sourcing and assembly of electronic components and may help in managing component availability, predicting market trends, and improving communication among stakeholders. Agriculture, which includes the production, distribution, and sale of agricultural products, may help predict crop yields, optimize distribution routes, and enhance collaboration between farmers, distributors, and retailers. Food and beverage, which includes the sourcing, processing, and distribution of perishable goods, may help in managing inventory, predicting demand, and improving traceability. Logistics and transportation includes the movement of goods from suppliers to consumers and may assist by optimizing routes, predicting shipping delays, and enhancing real-time tracking. Energy includes the production and distribution of energy resources and could help in predicting maintenance needs for infrastructure, optimizing distribution networks, and managing resource availability. Textiles and apparel includes the production and distribution of clothing and textiles and could help in managing inventory, predicting fashion trends, and optimizing production schedules.

In existing systems for C2C, issues arise that require input, validation, and approvals from various stakeholders for resolution. However, these systems may have deficiencies that hinder their efficiency, accuracy, and effectiveness. For instance, in critical C2C activities where structured communication is essential for collaboration, heavy reliance on manual communication (e.g., emails, phone calls, and meetings) introduces a host of inefficiencies, inaccuracies, delays, etc. The complexity of C2C processes, coupled with the diverse systems and tools in use, further compounds the inefficiencies of manual communication. Existing systems may not accurately relay information, track issue statuses, and may not provide consistent resolutions across systems and platforms, such as between parties to a contract.

Furthermore, the configuration of existing C2C communication delays a timely resolution of matters, an important aspect in C2C activities that demand quick decision-making. Communication processes may operate with a risk of miscommunication and errors. Delays in accurately relaying information among stakeholders may lead to misinterpretations, misunderstandings, or critical details being omitted. In such existing systems, miscommunications have the potential to trigger incorrect actions or decisions, with consequences that impede the overall C2C.

Another major drawback lies in the difficulty of tracking and ensuring accountability within these manual communication methods. The lack of transparency and automation makes it difficult to monitor the progress of issue resolution, leading to uncertainties about responsibilities and accountabilities. Consequently, issues might fall through the cracks or experience delays due to the absence of a streamlined process.

The lack of standardization in communication practices in existing systems, such as, for example, across different C2C functions or departments poses yet another challenge. With different stakeholders adopting varying approaches to handling similar issues, best practices and optimizing processes is neglected. Existing systems may not include automated messaging systems capable of efficiently handling C2C tasks, insufficient for this critical process. Such existing systems are insufficient to extend beyond communication. Existing C2C lacks efficient messaging systems. This significantly impacts the resolution and dispatch of activities.

Moreover, within these systems, structured email communication heavily relies on manual interventions, introducing further inefficiencies when managing critical activities within C2C. Transmissions of C2C requests and updates to both internal and external stakeholders may be inaccurate, or repetitious.

Additionally, existing systems often provide inefficient tracking of C2C workflows, may fail to offer interface control for external systems linked to contract resolution actions, and may not maintain sufficient accuracy, which in turn leads to errors and inconsistencies in C2C. This is in contrast to a manual approach to handling contract issues, which could take a significantly longer time to even notice a contract issue. By identifying and addressing exceptions quickly through the systems and methods provided herein, the likelihood of repeating mistakes is reduced, which is a key advantage of the automated approach.

The lack of advanced analytics in existing systems hampers the classification of contract actions into targeted workflows, while also hindering the identification of suitable recipients, impacting overall responsiveness.

Furthermore, the inability to transform contract exceptions into actionable inferences limits the activation of automated workflows and navigations of external systems during resolutions.

In terms of C2C, existing systems lack the necessary automation, leading to intensive interventions that cause delays, errors, and disputes with stakeholders. Delays in resolving contract exceptions, inefficient contract approvals and processing, and inaccurate predictions further compound the inefficiencies. Further, in a manual method, when a dispute arises, users may not effectively track each of the communication that occurs during the resolution process.

Existing systems ultimately struggle to accurately identify contract actions and determine suitable activities and response for approval processes. These inherent inefficiencies result in prolonged processing times and inadequate fulfillment of contract requests, thereby extending the challenges faced by organizations engaging in C2C.

Although individual team members can query and manipulate raw data from existing systems, what is needed is a unified platform that aggregates, organizes, and visualizes data daily, while also automating provision of actions and responses that are crucial to C2C. The limitations of current systems across these critical activities hinder operational efficiency, accuracy, and speed within C2C. Dynamic transformation of C2C is needed for generation of meaningful inferences by the platform. Automated actions, responses, and resolutions are needed for improvements to C2C communication process involving internal and external stakeholders. An automated solution is needed to streamline this communication process, leveraging dynamic activities for resolving issues.

Provided herein are improved methods, systems, and computer program products for efficient generation, communication and resolution of contract exceptions. For example, according to the methods, systems, and computer program products described herein, a C2C system to efficiently resolve contract exceptions is provided. The C2C system streamlines processes by providing contract workflows for issue resolution. Contract automation provides improvements to ensure relevant stakeholders are notified promptly, approvals are obtained efficiently, actions are taken according to predefined rules, and/or the like. C2C automation minimizes the risk of errors, accelerates response times, and improves the overall accuracy of C2C processes and related communications. Furthermore, utilizing an automated case creation approach allows for immediate deployment of call-to-action when an exception occurs.

In this way, non-limiting embodiments or aspects of the present disclosure provide an improved approach to C2C. The C2C system transforms contract exception resolution by optimizing the speed, accuracy, and efficiency of issue resolution across C2C. The approach streamlines C2C by integrating contract workflows with dynamic issue resolution. With contract automation, stakeholders receive prompt notifications, approvals are efficiently obtained, and actions adhere to predefined rules. By reducing the risk of errors, accelerating response times, and enhancing the accuracy of C2C processes and associated communications, this improved C2C system improves contract exception resolution efficiency across the entire C2C landscape.

The advantages of automating critical C2C activities are programmed or configured to improve the depth of inferences, improve predictive capabilities, and improve trend analysis crucial for high-performing C2C systems and processes. These improvements underscore the demand for innovative solutions that provide a proven, repeatable, and prescriptive process. Further advantages of automation for critical C2C activities, include the substantial reduction in time from automatic response and escalation, elimination of significant C2C activity processing, elimination of time intensive manual intervention, and/or significantly mitigating the errors that can arise from human oversight. The C2C systems provided herein, streamline and optimize workflows, ensuring smooth progress across various stages and systems.

Moreover, the capability for real-time monitoring of processes and transactions, exemplified by the C2C system, enables rapid identification and resolution of issues. By incorporating advanced analytics and machine learning algorithms, the C2C system facilitates predictive trend analysis and enhances decision-making. The new approach also ensures consistent processes throughout the C2C landscape, promoting uniform application of assessment criteria. Further, swift identification and handling of activities are core capabilities of the system, triggering predefined actions or notifications for efficient contract exception resolution.

The C2C system maintains a comprehensive record of each communication, including time stamps, that takes place during the dispute resolution process. This enhanced tracking and documentation streamlines dispute resolution and safeguards a clear record of communication, contributing to more efficient and accountable processes.

The improved C2C system effectively translates vast datasets into actionable inferences, providing improved automatic activities that may be guided by concrete data rather than assumptions. Through the automation of manual tasks, the system significantly reduces the administrative workload, freeing up valuable resources for more high-priority tasks, particularly critical in activities involving the processing of numerous requests. The C2C system also improves the quality level of the diagnosis process and communication process. The systems are inherently equipped to manage a substantial volume of transactions and processes, crucial for the complex and high-volume activities characteristic of C2C.

Further improvements may involve adapting C2C for alignment with evolving regulatory requirements and industry trends. The C2C system provides a significant advancement in critical C2C activities. By addressing limitations inherent in existing systems and offering improvements for efficiency, precision, real-time inferences, predictive capabilities, and standardized processes, the improved systems described herein provide centralized communication that simplifies the process of providing resources such as assistance, escalation of issues, and conducting audits.

In this way, the C2C system addresses inherent inefficiencies and challenges. By introducing automated activations of actions, standardized communication processes, and predictive capabilities, the system streamlines critical activities within healthcare supply chains. A match exception system, integrated into the C2C framework, significantly reduces manual interventions, mitigates errors, and accelerates response times. Further improvements provide improvements in the form of real-time monitoring, advanced analytics, and machine learning algorithms for predictive trend detection and informed decision-making. The system maintains a comprehensive record of communications, streamlining dispute resolution and ensuring accountability. Moreover, by translating vast datasets into actionable inferences, it optimizes the handling of a substantial volume of transactions, crucial for the complexity of healthcare supply chains. Accordingly, these improvements result in increased efficiency, precision, and adaptability marking a substantial advancement in procurement and critical healthcare supply chain activities.

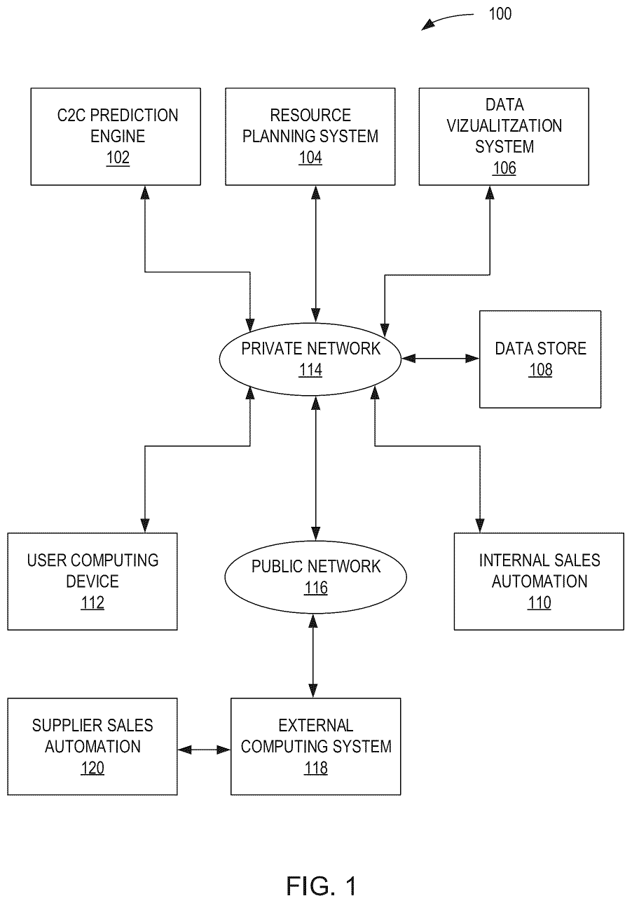

FIG. 1 shows an illustrative computing environment for executing a plurality of interacting pipelines performing C2C processing using cognitive automation tools in accordance with one or more example embodiments. With reference to FIG. 1, computing environment 100 may include one or more computer systems. For example, computing environment 100 may include C2C prediction engine 102 (e.g., a C2C prediction platform, a C2C prediction system, one or more devices of C2C prediction engine 102, etc.), resource planning system 104, data visualization system 106, data store 108, internal sales automation 110, user computing device 112, private network 114, public network 116, external computing system 118, and supplier sales automation 120.

In some non-limiting embodiments or aspects, C2C prediction engine 102 may include one or more computing devices configured to perform one or more functions for sourcing of concepts to contract as described herein. C2C prediction engine 102 may include one or more computers (e.g., laptop computers, desktop computers, servers, server blades, etc.) that provide integration and communication among the various systems within the supply chain. In addition, C2C prediction engine 102 activates (e.g., initiates, executes, determines, forecasts, predicts, etc.) one or more responses (e.g., reactions or actions taken in reply to specific events or triggers within C2C, including how stakeholders react to notifications, requests for approvals, other triggers within the system, and/or the like). Further contracts or actions (e.g., the specific steps or measures taken in response to identified issues, exceptions, or tasks within the C2C system, etc.) include tasks such as notifying stakeholders, obtaining approvals, or triggering predefined workflows to address and resolve contract-related issues and to complete activities that occur within the healthcare supply chain.

C2C prediction engine 102 possesses the capability to generate or invoke specific prediction models that are customized to various categories of accounts, suppliers, or transactions within its operational domain. By leveraging its advanced machine learning techniques, C2C prediction engine 102 determines solutions from diverse datasets associated with different entities and activities. As a result, it can create distinct models that capture the unique characteristics, patterns, and behaviors relevant to each type of account, supplier, or transaction. This tailored approach empowers C2C prediction engine 102 to provide accurate and targeted predictions, enhancing its ability to identify potential exceptions or anomalies within the healthcare supply chain based on the specific context of the situation.

In some non-limiting embodiments or aspects, C2C prediction engine 102 utilizes both supervised and unsupervised learning techniques as integral components of its operational methodology. For example, C2C prediction engine 102 learns one or more relationships (e.g., features, characteristics, etc.) between input data and corresponding desired outputs, allowing it to make predictions based on this learned knowledge and also learn from the inherent structure of the data, without predetermined labels, to uncover hidden inferences or anomalies that might not be apparent through other approaches. By incorporating both supervised and unsupervised learning techniques, C2C prediction engine 102 gains a comprehensive understanding of the data it processes. C2C prediction engine 102 may leverage the labeled data of resource planning system 104 to make accurate predictions in known scenarios, and also utilize unsupervised learning to discover novel patterns or anomalies that might indicate exceptions or incorrect activities within the healthcare supply chain (e.g., a combined approach to identify a wide range of potential match exceptions, etc.). C2C prediction engine 102 encompasses functions for generating prediction models specific to various accounts, suppliers, based on training data using machine learning techniques or transactions, performing supervised and unsupervised learning, predicting responses or actions, providing efficient integration and communication between supply chain systems, and/or the like.

In some non-limiting embodiments or aspects, resource planning system 104 may include one or more computing devices and/or other computer components (e.g., processors, memories, communication interfaces). In addition, and as illustrated in greater detail below, resource planning system 104 may be configured to interact with and/or otherwise communicate with one or more computing devices and/or other devices (e.g., customer computing devices, healthcare center computing devices, sales force automation computing devices, etc.) which may receive and/or process items (e.g., purchase orders, vouchers, agreements, etc.) being presented for payment at various locations and/or via various channels. Resource planning system 104 encompasses functions such as automating order processing across a general ledger with multiple accounts, monitoring and intercepting invoices, purchase orders, and transaction records, capturing payment indicators, costs, and exceptions associated with healthcare transactions, managing and accounting for medical inventory, including high-value and low-value items, tracking and managing inventory from value analysis to delivery through to usage, processing data related to usage for inventory management and procurement decisions, managing and integrating core business processes (finance, HR, supplier and inventory management) in a single system, automating basic accounting, invoicing, healthcare analysis, forecasting, and reporting through the ERP finance component, managing healthcare transactions and accounting for multiple healthcare units, suppliers, or patients, and handling order management, CRM, purchasing, and HR functions. Moreover, resource planning system 104 also handles employee records, benefits management, and payroll through the ERP HR component.

In some non-limiting embodiments or aspects, resource planning system 104 automates order processing across a general ledger with multiple accounts. For example, resource planning system 104 monitors and intercepts invoices, purchase orders, and transaction records. Resource planning system 104 may capture (e.g., determine, etc.) one or more payment indicators, costs, or exceptions tied to healthcare transactions. For example, resource planning system 104 manages and accounts for medical inventory, covering items of both high and low value. Resource planning system 104 tracks and manages inventory throughout its lifecycle, from value analysis to delivery and usage. Resource planning system 104 processes usage-related data to aid in inventory management and procurement decisions.

In some non-limiting embodiments or aspects, resource planning system 104 integrates and manages core business processes (e.g., finance, HR, supplier, and inventory management) within a single system. For example, resource planning system 104 may combine and oversee essential functions and activities related to various fundamental aspects of the business. These aspects include financial management, HR, supplier relationships, and inventory management. The system serves as a centralized platform where these critical operations are coordinated, synchronized, and streamlined, enhancing efficiency and facilitating smoother interactions between different components of the organization.

Further, resource planning system 104 automates basic accounting, invoicing, healthcare analysis, forecasting, and reporting through the ERP finance component. For example, resource planning system 104 includes functionalities that enable the automation of essential financial and administrative tasks. As an example, resource planning system 104 performs steps including managing financial records, generating invoices, conducting analysis related to healthcare operations, making forecasts, and generating reports. This automation is facilitated through the use of an ERP finance component, providing financial management within the broader ERP system. By automating these tasks, the system streamlines operations, reduces manual effort, enhances accuracy, and supports effective decision-making processes within the organization's financial and operational activities. Furthermore, the system pulls vendor contact information from the accounts payable (AP) data. This information is sourced from an approved vendor list, which includes relevant contact details. This safeguards that the system has accurate and up-to-date vendor contact information for communication related to C2C resolution and other related activities.

Resource planning system 104 handles healthcare transactions and accounting across multiple units, suppliers, and human resources. For example, resource planning system 104 is responsible for managing and overseeing various aspects of financial transactions and accounting within the healthcare domain. This includes activities related to different healthcare units, suppliers providing goods or services to those units, and patients who are recipients of healthcare services. The system integrates supply chain management (“SCM”), AP, and human resources (“HR”) data. HR data is used to maintain an up-to-date list of employees within the organization, which helps in identifying internal recipients of emails and safeguards accuracy even when someone leaves the company. AP data, which includes information about AP processes, is used to determine the nature of the concept and how they are related to the contract (e.g., impact on the contract negotiation, formation, changes, etc.).

Resource planning system 104 is configured to track and record financial transactions occurring between different healthcare units, ensuring accurate and transparent accounting. It also facilitates the management of supplier-related transactions (e.g., processing invoices, purchase orders, payment records, etc.). Furthermore, the system plays a role in handling financial aspects associated with patient services, by determining billing, invoicing, and record-keeping related to patient care. In this way, resource planning system 104 handles transactions and accounting across elements of the healthcare ecosystem and thereby, contributes to efficient financial management, accurate record-keeping, and seamless coordination within the healthcare organization.

In some non-limiting embodiments or aspects, data visualization system 106 provides inferences from visual representations based on data processed by C2C prediction engine 102. In such an example, data visualization system 106 is configured to interpret and present information derived from C2C prediction engine 102 in a visual and easily understandable format. As C2C prediction engine 402 processes complex data and performs various predictive analyses, data visualization system 106 takes the outcomes of these analyses and translates them into visual displays, charts, graphs, and other visual representations. In some examples, visuals allow users to quickly grasp trends, patterns, and anomalies within the healthcare supply chain, enabling them to make informed decisions and take appropriate actions based on the inferences derived from the data.

As an example of an efficiency, data visualization system 106 enhances the overall usability of C2C prediction engine 102 by converting processed data and predictions into visually accessible forms (e.g. visual interface, etc.). This visual interface aids users in comprehending the information more effectively and leveraging it to optimize their supply chain management strategies.

Resource planning system 104 manages order processing, CRM, purchasing, and HR functions by overseeing and coordinating various elements of the organization's operations. Specifically, resource planning system 104 includes functions related to order processing, which may include the entire workflow (or portions of the workflow), for receiving, fulfilling, and managing customer orders. It also handles CRM tasks, which include managing interactions with customers, maintaining customer records, and ensuring positive customer experiences. Additionally, the system takes care of purchasing activities, including procurement of goods and services needed for the organization's operations. Lastly, resource planning system 104 plays a role in managing HR functions, which may include tasks (e.g., employee records, benefits management, payroll processing, etc.). In this way, resource planning system 104 may streamline and integrate one or more diverse functions into a cohesive overarching system. This integration means that information flows seamlessly across platforms (e.g., between one or more functions of one or more systems of computing environment 100, etc.), thereby generating accurate and up-to-date data sharing and reducing the need for manual data entry. For example, when an order is processed, the system can automatically update inventory levels, trigger procurement processes, and notify relevant departments across an enterprise, enhancing the organization's overall operational efficiency. By centralizing these functions within a single system, resource planning system 104 safeguards that various departments and teams have access to consistent and accurate data, leading to better decision-making, improved coordination, and ultimately, enhanced efficiency throughout the organization's processes.

In addition, by linking the ERP with CRM, this allows auto case create and auto case close. For example, when the ERP system is connected or integrated with the customer relationship management system, it enables the automation of creating and closing cases. The integration allows for automatic creation of such cases based on certain triggers or conditions, and also the ability to automatically close these cases once they are resolved.

In some non-limiting embodiments or aspects, resource planning system 104 provides order processing across a general ledger with multiple accounts. C2C prediction engine 102 determines or predicts one or more match exceptions based on information associated with problems caused by streamlining the processing of orders across various accounts, thereby ensuring accurate and timely execution of transactions while reducing the chances of errors and discrepancies that can lead to exceptions.

In some non-limiting embodiments or aspects, resource planning system 104 monitors and intercepts invoices, purchase orders, and transaction records. C2C prediction engine 102 determines or predicts one or more match exceptions based on information associated with various transaction-related documents, to identify discrepancies associated with one or more match exceptions, allowing for timely intervention and resolution (e.g., a conclusion or settlement of identified issues, sourcing, or contract negotiation within the C2C management process, indicating the completion of the necessary actions and/or activities to address and resolve issues, etc.).

In some non-limiting embodiments or aspects, resource planning system 104 captures payment indicators, costs, and exceptions associated with healthcare transactions. C2C prediction engine 102 determines or predicts one or more match exceptions based on information associated with capturing critical data related to payments, costs, and potential exceptions within healthcare transactions, resulting in accurate capture of information essential for identifying anomalies resulting in match exceptions.

In some non-limiting embodiments or aspects, resource planning system 104 manages or accounts for medical inventory, including high-value and low-value items. C2C prediction engine 102 determines or predicts one or more match exceptions based on information associated with effective inventory management, including determining matching exceptions for items of varying values to avoid shortages, overages, and discrepancies that can result in exceptions.

In some non-limiting embodiments or aspects, resource planning system 104 tracks or manages inventory, for example during value analysis, delivery, usage, and/or the like, so that the supply chain remains transparent. C2C prediction engine 102 determines or predicts one or more match exceptions based on information associated with continuous tracking of inventory, so that anomalies can be detected promptly.

In some non-limiting embodiments or aspects, resource planning system 104 processes data related to usage for inventory management and procurement decisions. C2C prediction engine 102 determines or predicts one or more match exceptions based on information associated with stored decisions regarding inventory management and procurement, thereby minimizing the likelihood of exceptions caused by incorrect data interpretation.

In some non-limiting embodiments or aspects, resource planning system 104 manages or integrates core business processes (finance, HR, supplier and inventory management, etc.) in a single system. C2C prediction engine 102 determines or predicts one or more match exceptions based on information associated with the integration of one or more core processes to provides a holistic view of operations, thereby enabling faster detection and resolution of anomalies that may trigger exceptions.

In some non-limiting embodiments or aspects, resource planning system 104 automates basic accounting, invoicing, healthcare analysis, forecasting, and reporting (ERP finance component). C2C prediction engine 102 determines or predicts one or more match exceptions based on information associated with one or more automated processes to maintain accuracy and consistency across various financial tasks, which in turn reduces the risk of exceptions due to human error.

In some non-limiting embodiments or aspects, resource planning system 104 manages healthcare transactions and accounts for multiple healthcare units, suppliers, or patients. C2C prediction engine 102 determines or predicts one or more match exceptions based on information associated with management of transactions involving multiple entities, such that discrepancies and exceptions are quickly addressed, maintaining the integrity of the supply chain.

In some non-limiting embodiments or aspects, resource planning system 104 handles order management, CRM, purchasing, and HR functions. C2C prediction engine 102 determines match exceptions, or the likelihood of match exceptions, arising from miscommunication or inefficiencies based on one or more problems associated with functions supporting interactions among various stakeholders.

In some non-limiting embodiments or aspects, resource planning system 104 operates in an interconnected environment that leverages external systems and networks for supplier management. C2C prediction engine 102 leverages the interconnected environment and seamless communication with suppliers, allowing for timely sharing of information and reduced chances of exceptions due to communication gaps.

Resource planning system 104 manages employee records, benefits, and payroll through the ERP HR component to ensure that employees are paid accurately and on-time, while accounting for factors (e.g., hours worked, deductions, taxes, other applicable variables, etc.). More specifically, the system plays a role in managing employee records, which includes maintaining and updating information about employees (e.g., personal details, job roles, performance evaluations, and any changes in their employment status, or in some instances, may also include keeping track of historical data related to employees' roles and responsibilities, etc.). Furthermore, resource planning system 104 is responsible for managing employee benefits, which may include handling various benefits offered to employees (e.g., health insurance, retirement plans, paid time off, other perks, etc.). The system ensures accurate administration and distribution of these benefits, making sure that employees receive their entitled benefits in a timely manner. Additionally, resource planning system 104 manages payroll through the ERP HR component. This entails automating the process of calculating and disbursing employee salaries, wages, and other compensation. The integration of these HR functions within resource planning system 104 streamlines HR processes, reduces the chances of errors, and enhances efficiency by eliminating the need for manual handling of employee-related data and payroll calculations. This integrated approach also enables better data accuracy or compliance with regulations for employee-related matters.

In some non-limiting embodiments or aspects, data visualization system 106 includes one or more computing devices and/or other computer components (e.g., processors, memories, communication interfaces). In addition, data visualization system 106 may be configured to interact with and/or otherwise communicate with one or more computing devices and/or other devices (e.g., enterprise resource systems, database management systems, workflow systems, sales automation systems, etc.) which may receive and/or process accounts and associated payment information. Data visualization system 106 is responsible for interacting with enterprise resource systems, database management systems, workflow systems, and sales automation systems, presenting accounts and associated payment information in a visual and understandable format, providing inferences and visual representations based on data, and enhancing value analysis and item management through predictive actions and interpretations.

In some non-limiting embodiments or aspects, data visualization system 106 interfaces with various components of computing environment 100. Data visualization system 106 may provide a comprehensive view of data. For example, a visualization of the data from multiple sources of computing environment 100 may provide a holistic understanding of the supply chain.

Data visualization system 106 provides information in a visual and understandable format, including accounts and payment information, into visual representations that are easy to comprehend.

In some non-limiting embodiments or aspects, data visualization system 106 acts as a vital tool for comprehending and leveraging data across the supply chain. Data visualization system 106 provides seamless communication with other enterprise systems, transforms complex information into easily understandable visuals, provides actionable inferences based on processed data, and contributes to optimized value analysis and item management. Through these functions, data visualization system 106 enhances the overall functioning of the supply chain management system and its ability to handle C2C effectively.

Data store 108 provides a repository for various types of data that are relevant to C2C prediction engine 102. This could include historical transaction data, account information, supplier details, past exceptions, and other relevant datasets. The data may be stored in an organized manner, making it easily retrievable when needed for analysis, modeling, and prediction.

In some non-limiting embodiments or aspects, C2C prediction engine 102 interacts with data store 108 to access (or store) the necessary information for its predictive analysis. It may retrieve data from the database to build and train prediction models. The data store acts as a central hub where different sources of data are integrated, enabling C2C prediction engine 102 to have a comprehensive view of the healthcare supply chain's historical activities and patterns.

In some non-limiting embodiments or aspects, machine learning models operating within C2C prediction engine 102 may include a significant storage amount of training data to make accurate predictions. Data store 108 maintains or provides this data for model training purposes. C2C prediction engine 102 may obtain or receive relevant data from the database to train and refine its prediction algorithms.

In some non-limiting embodiments or aspects, computing environment 100 includes a healthcare supply chain, such that new supply chain data is constantly generated. Data store 108 provides real-time or periodic updates so that the prediction models are up-to-date and reflective of the latest trends and activities.

In some non-limiting embodiments or aspects, data store 108 performs data cleansing and preprocessing. For example, before using the data, C2C prediction engine 102 may preprocess the data (e.g., automatically preprocess, etc.), cleanse it, remove inconsistencies, remove errors, or remove irrelevant information. This preprocessing could include tasks such as data normalization, handling missing values, and data transformation. Data store 108 could potentially include features to assist with these tasks.

In some non-limiting embodiments or aspects, data store 108 provides data security and access control. For example, data stored in data store 108 may be sensitive and valuable. Data store 108 determines robust security measures to protect the data, including user authentication, access controls, encryption of data at rest, and audit trails to track who accessed the data and when, and/or the like.

In some non-limiting embodiments or aspects, data store 108 provides scalability and performance: For example, data store 108, as the amount of data grows over time, provides scalability and performance. Data store 108 may be configured to efficiently handle large volumes of data and providing rapid access for analysis and prediction tasks.

In some non-limiting embodiments or aspects, data store 108 provides retrospective analysis, reporting, and generating inferences into past sourcing of contracts and supply chain activities to identify in combination with trends, areas for improvement, and potential strategies to source future contracts.

In some non-limiting embodiments or aspects, user computing device 112 may be a personal computing device (e.g., desktop computer, laptop computer) or mobile computing device (e.g., smartphone, tablet). In addition, user computing device 112 may be linked to and/or used by an enterprise user (who may, e.g., be an employee of a healthcare institution operating C2C prediction engine 102). For example, user computing device 112 may be used by an enterprise associate who manually processes and/or reviews sourcing activities or items. Additionally, user computing device 112 includes functions for processing and review of sourcing activities, as well as configuration and monitoring of C2C prediction engine 102 and other enterprise computing devices.

Supplier sales automation system 120 also may be a personal computing device (e.g., desktop computer, laptop computer) or mobile computing device (e.g., smartphone, tablet). In addition, supplier sales automation system 120 may be linked to and/or used by an enterprise user (e.g., an employee of a healthcare institution operating C2C prediction engine 102). For example, supplier sales automation system 120 may be used by a network administrator or backend enterprise user who monitors and/or configures C2C prediction engine 102 and/or other enterprise computing devices.

External computing system 118 may include one or more computing devices and/or other computer components (e.g., processors, memories, communication interfaces). In addition, and as illustrated in greater detail below, external computing system 118 may be linked to and/or used by an external organization (e.g., an organization different from a healthcare institution operating C2C prediction engine 102). For example, external computing system 118 may be used by a third-party healthcare institution in presenting and/or otherwise submitting one or more account items to C2C prediction engine 102 and/or a healthcare institution operating C2C prediction engine 102.

Computing environment 100 also may include one or more networks, which may interconnect one or more of C2C prediction engine 102, resource planning system 104, and data visualization system 106, user computing device 112, external computing system 118, and supplier sales automation system 120. For example, computing environment 100 may include private network 114 (which may interconnect with an exception prediction engine (not shown) or procurement prediction engine (not shown), resource planning system 104, data visualization system 106, user computing device 112, one or more other systems which may be associated with an organization, a healthcare institution, etc.) and public network 116 (which may interconnect supplier sales automation 120 and/or external computing systems 118 with private network 114, one or more other systems, public networks, sub-networks, and/or the like).

In some non-limiting embodiments or aspects, user computing device 112 may monitor and configure the procurement inference engine and other enterprise computing devices, and also facilitates the monitoring and configuration of the procurement inference engine and other enterprise computing devices. This active oversight ensures that these systems operate optimally, align with business objectives, and respond effectively to changing conditions.

In some non-limiting embodiments or aspects, resource planning system 104, data visualization system 106, user computing device 112, external computing system 118, supplier sales automation system 120, and/or the other systems included in computing environment 100 may be any type of computing device capable of receiving a user interface, receiving input via the user interface, and communicating the received input to one or more other computing devices. For example, resource planning system 104, data visualization system 106, user computing device 112, external computing system 118, supplier sales automation system 120, and/or the other systems included in computing environment 100 may, in some instances, be server computers, desktop computers, laptop computers, tablet computers, smart phones, or the like, that may include one or more processors, memories, communication interfaces, storage devices, and/or other components. As noted above, and as illustrated in greater detail below, any and/or all of C2C prediction engine 102, resource planning system 104, data visualization system 106, user computing device 112, external computing system 118 and supplier sales automation system 120, may, in some instances, be special-purpose computing devices configured to perform specific functions.

In some non-limiting embodiments or aspects, external computing system 118 provides an electronic interface and connector between external entities and the internal systems of the supply chain framework.

In some non-limiting embodiments or aspects, external computer system 118 submits account items and relevant data for C2C processing. For example, external computer system 118 allows external organizations (e.g., one or more third-party healthcare institutions, suppliers, etc.) to submit account items and associated data to the C2C prediction platform. This function facilitates the inclusion of external data in the predictive analysis and C2C handling processes.

In some non-limiting embodiments or aspects, external computer system 118 facilitates communication and integration with the C2C prediction platform. For example, external computer system 118 serves as a bridge for communication and integration between the external elements and C2C prediction engine 102, so that data and information flow efficiently between elements of the supply chain management ecosystem.

In some non-limiting embodiments or aspects, external computer system 118 is configured to interact with the resource planning system and the data visualization system. For example, external computer system 118 is capable of interacting with both the resource planning system and the data visualization system. This interaction includes a secure connection of the external entity to engage with and access relevant information and inferences from one or more systems.

In some non-limiting embodiments or aspects, external computer system 118 supports the transmission of supply information within a supplier system. For example, external computer system 118 obtains supply-related information within a supplier's system, for accurate and up-to-date records and data within the supplier's domain.

External computer system 118 provides a communication hub and liaison between external entities and the internal supply chain management systems. External computer system 118 receives external data, integrates with the C2C prediction platform, interacts with the resource planning and data visualization systems, and facilitates the exchange of supply-related information within a supplier's system. This integration includes the flow of information, collaboration, and overall efficiency within the supply chain management ecosystem.

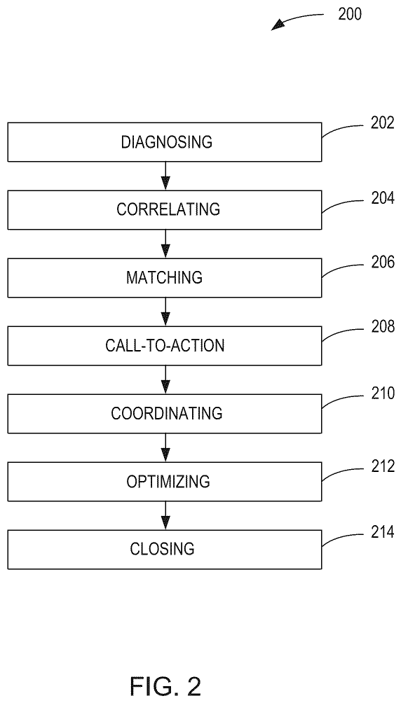

In some non-limiting embodiments or aspects, C2C prediction engine 102 includes one or more processors, memories, and communication interfaces, as described in further detail with reference to FIG. 2. A data bus interconnects the processor, the memory, and the communication interface. The memory contains program modules and processing engines with instructions that, when executed by the processor, enable C2C prediction engine 102 to perform functions as described herein. It also stores databases that maintain information used by these program modules, processing engines, and the processor. In certain instances, these program modules, processing engines, and databases are stored in different memory units of C2C prediction engine 102 or different computing devices that make up C2C prediction engine 102. For example, the memory may contain a C2C processing module, a C2C processing database, and a C2C item learning engine.

C2C prediction engine 102 may perform improved sourcing processing using cognitive automation tools, as discussed in greater detail below. Data store 108 (e.g., exception processing database, exception database programming, etc.) may store sourcing prediction data or may generate sourcing prediction information using programming in C2C prediction engine 102, such as C2C item learning in C2C prediction engine 102 to perform one or more cognitive automation and/or machine learning function and/or service, as illustrated in greater detail below.

In some non-limiting embodiments or aspects, C2C prediction engine 102 utilizes machine learning techniques (e.g., supervised and unsupervised learning, e.g., predictive models for identifying supply chain anomalies, sentiment analysis of supplier communications, etc.) for generating models. C2C prediction engine 102 analyzes training data to create prediction models, classification models, segmentation models, etc. (e.g., predicting demand for specific medical supplies, classifying suppliers based on performance levels, etc.). C2C prediction engine 102 employs new models and advancements in computational power for practical applications (e.g., incorporating state-of-the-art deep learning models for improved accuracy, leveraging faster GPUs for quicker predictions, etc.). C2C prediction engine 102 supports inference engines for executing model algorithms and generating inference outputs (e.g., suggesting optimal reorder quantities, highlighting potential fraudulent activities, etc.). C2C prediction engine 102 generates and provides mission-critical healthcare information using machine learning (e.g., forecasting supply chain disruptions, predicting patient demand patterns, etc.). C2C prediction engine 102 automates processes and actions such as interpreting communications and predicting responses (e.g., automatically flagging discrepancies in transaction data, predicting supplier responses to potential delays, etc.).

In some non-limiting embodiments or aspects, C2C prediction engine 102 engages in supervised learning by approximating the mapping function from known input variables to output variables for predictions (e.g., predicting future order quantities based on historical data, estimating lead times for suppliers, etc.). C2C prediction engine 102 addresses regression problems, solving for real-value output variables (e.g., dollars or items, e.g., forecasting future costs based on historical spending patterns, predicting the price of medical supplies, etc.). C2C prediction engine 102 tackles classification problems, solving for categorical output variables (e.g., pending/closed, compliant/non-compliant, e.g., categorizing transactions as urgent or non-urgent, classifying suppliers into high-risk or low-risk categories, etc.).

C2C prediction engine 102 also utilizes unsupervised learning to model the underlying structure or distribution in the data (e.g., identifying patterns in supplier behaviors, clustering similar types of orders, etc.). C2C prediction engine 102 addresses clustering problems, discovering inherent groupings in a dataset (e.g., grouping similar suppliers based on performance metrics, clustering orders based on delivery locations, etc.). C2C prediction engine 102 deals with the association rule learning problem, discovering rules that describe large portions of data (e.g., identifying purchasing patterns based on historical transaction data, uncovering associations between suppliers and product categories, etc.).

In addition to identifying patterns based on transaction history or uncovering associations between suppliers and product categories, C2C prediction engine 102 may provide customizable filters within C2C prediction engine 102. For example, users applying their own criteria to filter data before using C2C prediction engine 102 may operate a user interface for implementing such filters. In such an example, recent activities are filtered out for a specific period of time before being included in the analysis (e.g., 10 days, a month, etc.).

In some non-limiting embodiments or aspects, C2C prediction engine 102 is trained in machine learning models using various techniques and algorithms (e.g., utilizing decision trees to predict contract fulfillment outcomes, employing neural networks to forecast demand fluctuations within the C2C process, etc.). C2C prediction engine 102 analyzes training data to generate models for problem-solving in diverse variations (e.g., creating different prediction models for supplier behavior in C2C, adjusting models based on different product categories relevant to C2C, etc.). C2C prediction engine 102 employs cognitive automation tools to enhance supplier processing within the C2C framework (e.g., automating communication with suppliers to resolve automatically routing contract-related matters to appropriate teams based on predictions within the C2C process, etc.). C2C prediction engine 102 predicts actions, responses, and interprets operating parameters correlated with critical parameters within the C2C context (e.g., predicting when to expedite contract orders based on changing demand patterns in C2C, interpreting supplier responses to C2C contract delays, etc.). C2C prediction engine 102 increases efficiencies in healthcare records, data storage, and item management within the C2C process (e.g., optimizing inventory levels to minimize excess stock and shortages specifically related to C2C contracts, efficiently managing supply lifecycle within C2C, etc.). C2C prediction engine 102 enhances workflow and targeted communications for efficiency and accuracy within the C2C process (e.g., automating handling C2C contract pipelines, sending real-time alerts to relevant stakeholders based on predictions within C2C, etc.).

In some non-limiting embodiments or aspects, private network 114 and public network 116 may include one or more wired and/or wireless networks. For example, private network 114 and public network 116 may include a cellular network (e.g., a long-term evolution (LTE) network, a third generation (3G) network, a fourth generation (4G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with a transaction service provider), an ad hoc network, an intranet, the Internet, a fiber optic-based network, a cloud computing network, and/or the like, and/or a combination of these or other types of networks.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of computing environment 100 may perform one or more functions described as being performed by another set of systems or another set of devices of computing environment 100.

Referring now to FIG. 2, FIG. 2 is a diagram of a non-limiting embodiment of workflow 200 for automating C2C processing across interacting pipelines for each contract in a C2C system. In some non-limiting embodiments, one or more of the steps of workflow 200 are performed (e.g., completely, partially, etc.) by C2C prediction engine 102. For example, one or more steps of workflow 200 are performed by C2C prediction engine 102 (e.g., one or more devices of C2C prediction engine 102), resource planning system 104 (e.g., one or more devices of resource planning system 104, etc.), data visualization system 106 (e.g., one or more devices of data visualization system 106), data store 108 (e.g., one or more tables, one or more linked tables, one or more linked databases, etc.), internal sales automation 110, user computing device 112 (e.g., one or more devices of user computing device 112), external computer system 118 (e.g., one or more devices of external computer system 118), and a supplier sales automation system 120 (e.g., one or more devices of supplier sales automation 120).

As shown in FIG. 2, at step 202, workflow 200 includes diagnosing. In some non-limiting embodiments or aspects, C2C prediction engine 102 diagnoses a condition. For example, C2C prediction engine 102 reviews (e.g., obtains, assess, etc.) the current status of cases within the resource planning system, such as contract expirations and pending actions. In some examples, C2C prediction engine 102 obtains the current status of cases within an associated resource planning system 104 to determine when any specific conditions or criteria have been met. Resource planning system 104 collects data. For example, resource planning system 104 gathers relevant data and information related to the procurement process. This data can include details about existing contracts, contract terms, expiration dates, product information, critical parameters, and/or the like.

In some non-limiting embodiments or aspects, diagnosing includes defining an understanding of the current state of the C2C process. In some examples, diagnosing includes assessing the condition of the system or specific contracts, identifying any issues, and determining the need for action. This step may also include evaluating various aspects of contracts, such as contract performance, compliance, or upcoming expiration dates.

In some non-limiting embodiments or aspects, C2C prediction engine 102 diagnoses to determine the classification in one or more contract categories. In an example, the contract categories may include contract terms, pricing, delivery, and order status. In some examples, a contract term category comprises cases that includes discrepancies related to contract terms (e.g., ensuring that the delivered products or services adhere to the contract terms, managing changes to the contract, handling renegotiations, etc.). In some examples, a pricing category includes cases related to pricing and financial matters. The pricing category focuses on cases where pricing must align with contract terms, both for contract and non-contract agreements. It safeguards accurate pricing, adherence to contract terms, and appropriate financial transactions. In some examples, a delivery category comprises cases associated with the delivery and receipt of goods or services as specified in the contracts. This category addresses scenarios where the delivered quantity matches or does not match the contracted quantity, ensuring timely and accurate delivery, and resolving discrepancies promptly. In some examples, an order status category includes cases connected to the status of orders within the contracts. It addresses cases where orders are complete, pending approval, or pending dispatch. Efficient handling safeguards smooth processing of orders, minimizes delays, and maintains effective communication between included parties for timely contract fulfillment. These categories streamline C2C workflow 200 by providing a clear distinction for addressing specific types of contract exceptions, allowing for efficient and targeted resolution processes.

As shown in FIG. 2, at step 204, workflow 200 includes correlating. In some non-limiting embodiments or aspects, C2C prediction engine 102 correlates one or more operating parameters with one or more critical parameters. For example, correlating focuses on connecting data and parameters to find relationships and dependencies, such as data from different sources including operating parameters that can be analyzed to uncover connections with critical parameters (e.g., the need for contract renewal, pricing adjustments, or performance issues, etc.). C2C prediction engine 102 correlates to form a connection between one or more operating parameters (e.g., either alone or in combination) and one or more critical parameters (e.g., either alone or in combination) for the C2C process. Operating parameters may be defined based on the goals, objectives, and key performance indicators (KPIs) of a procurement and the C2C process (e.g., an organizational need, goal, etc.).

In some non-limiting embodiments or aspects, operating parameters may include at least one of: product information (e.g., details about the products or services being procured, such as product name, item number, catalog number, product description, cost, estimated usage per year, etc.), financial information (e.g., cost, budget allocation, cost analysis, etc.) which are essential for decision-making during the procurement process, supplier information (e.g., information about one or more suppliers, including details, performance history, reliability, etc.), request details, such as parameters related to the request for procurement (e.g., requestor, initiator, request date, type of request, including emergency preparedness, service, construction, etc.), contract information including information about existing contracts (e.g., contract owners, expiration dates, terms and conditions, pricing details, etc.), funding information including details about funding sources, budgets, and project-specific funding allocations, inventory information (e.g., inventory items, manufacturer details, vendor details, stock availability, etc.), and procurement type indicating the type of procurement (e.g., direct purchase, competitive bidding, negotiation, etc.).

In some non-limiting embodiments or aspects, critical parameters may include at least one of: contract threshold value (e.g., a predefined value used for comparing and evaluating the criticality of a contract or procurement decision, etc.), where contracts or procurements with values beyond this threshold may require different actions, performance metrics (e.g., key performance indicators (KPI) related to supplier performance, contract compliance, cost savings, contract efficiency, etc.), contract maintenance factors, such as a need to assign an owner, contract cancellation, changes in price, performance notifications, and other critical events related to C2C, funding approval indicating whether a procurement request has received the necessary funding approval or if additional financial review is required, legal and privacy compliance ensuring that contracts and procurements comply with legal and privacy regulations and standards, risk management for assessing and managing risks associated with procurement decisions, including risk tolerance levels and mitigation strategies.

In some non-limiting embodiments or aspects, the operating parameters are determined from the one or more data elements used to make decisions, while the critical parameters are the key indicators for determining how significant a contract or a procurement decision is and/or what actions need to be taken.

Use the collected data to analyze the current state of the C2C process. This includes evaluating the status of existing contracts, assessing the performance of suppliers, identifying any upcoming contract expirations, and/or the like.

For example, setting diagnostic criteria that define specific diagnostic criteria or thresholds to be met for certain actions may include setting criteria for contract renewal, supplier performance evaluation, or cost analysis.

For example, comparing with threshold values to compare the current state and collected data with the predefined concept threshold values. These values are established based on the organization's policies, objectives, and best practices. For example, if a contract is nearing its expiration date, it may trigger a diagnostic process.

For example, identifying action triggers to determine the actions or responses that to be initiated when the diagnostic criteria are met. These actions can include contract renewal, supplier negotiation, cost analysis, or even the creation of a new contract.

For example, decision making may be based on the diagnostic results and the identified action triggers. For example, if a contract is approaching its expiration date and meets specific criteria, the decision might be to initiate the renewal process.

For example, executing actions, including generating new contracts, communicating with suppliers, or updating contract terms. The diagnostic process in c2c performs based on predefined criteria and the current state of the procurement process to improve and optimize contract management.

As shown in FIG. 2, at step 206, workflow 200 includes matching. For example, matching of operating and critical parameters is based on predefined rules, thresholds, decision criteria, and/or the like to evaluate and assess the significance of a contract or procurement decision. Matching includes collecting relevant data and operating parameters associated with the contract or procurement decision. This data can come from various sources, including product information, financial data, supplier details, request specifics, contract terms, and/or the like.

In some non-limiting embodiments or aspects, a set of rules and criteria are generated that determine how operating parameters should be evaluated against critical parameters. These rules are often based on organizational policies, best practices, and industry standards.

In some non-limiting embodiments or aspects, threshold values are established for critical parameters. Such threshold values serve as benchmarks to categorize the importance of a contract or procurement decision. For example, a higher contract value may have a different threshold than a lower one.

In some non-limiting embodiments or aspects, the values of the operating parameters are compared with the predefined critical parameters and threshold values. The comparison is performed as an automated system for the decision-making process. For example, C2C prediction engine 102 performs many comparisons and may provide scoring and/or ranking. C2C prediction engine 102 may assign scores or rankings to the contract or procurement decision based on the results of the comparison. This scoring is then used to determine the significance of the decision based on the critical parameters. C2C prediction engine 102 may classify the contract or procurement decision into categories based on the assigned scores or rankings. For example, decisions can be categorized as high priority, medium priority, or low priority. Then depending on the classification, predefined actions are determined. For high-priority decisions, more rigorous actions may be required, such as thorough legal review, negotiation, or approval from executive management. For lower-priority decisions, standard processes may suffice.

As shown in FIG. 2, at step 208, workflow 200 includes determining a call-to-action. For example, C2C prediction engine 102 determines a call-to-action. For example, in some non-limiting embodiments or aspects, once the actions are determined, the system communicates and executes the necessary steps to generate notifications, sending out alerts, triggering workflows, and initiating the procurement process.

As shown in FIG. 2, at step 210, workflow 200 includes coordinating a response. In some non-limiting embodiments or aspects, C2C prediction engine 102 coordinates a response. For example, C2C prediction engine 102 (or other systems shown in FIG. 1) continuously monitor the progress of the concept sourcing, contract creation, or procurement decision. C2C prediction engine 102 generates the call-to-action. In addition, C2C prediction engine 102 safeguards that actions are executed in a timely and accurate manner.

In some non-limiting embodiments or aspects, coordinating the response includes clear and timely communication between stakeholders. This may include C2C prediction engine 102 notifying team members, suppliers, or other relevant parties about the planned action and its implications.

In some non-limiting embodiments or aspects, C2C prediction engine 102 may generate and maintain accurate and up-to-date documentation (e.g., contracts, agreements, approvals, relevant records, etc.) of each activity (e.g., various processes, tasks, and workflows involved in managing contracts, including actions taken to initiate, process, and conclude contract-related tasks, ranging from communication between stakeholders to the handling of exceptions, approvals, responses, other actions integral to C2C, and/or the like). Additionally, C2C prediction engine 102 may activate a communication or action to be executed with respect to a related contract or procurement decision.

In some non-limiting embodiments or aspects, C2C prediction engine 102 tracks the progress of each task and activity within the workflow. C2C prediction engine 102 may implement real-time visibility into the status of the response received. In some examples, C2C prediction engine 102 identifies any bottlenecks or issues that need to be addressed.

In some non-limiting embodiments or aspects, C2C prediction engine 102 provides escalation of a case when an issue or roadblock arises during the response coordination. C2C prediction engine 102 escalates the communication or action to safeguard that challenges are addressed promptly and that the response remains on track.

As shown in FIG. 2, at step 212, workflow 200 includes optimizing. In some non-limiting embodiments or aspects, C2C prediction engine 102 optimizes. For example, C2C prediction engine 102 implements a feedback loop that provides continuous improvement of the matching process. For example, C2C prediction engine 102 provides continuous improvement to the effectiveness of each rule, criteria, and thresholds and adjust them as needed.

In some non-limiting embodiments or aspects, C2C prediction engine 102 may predict future outcomes based on historical data. For example, C2C prediction engine 102 optimizes by predicting supplier performance, contract risks, cost trends, and/or the like, to make informed decisions and take proactive optimization actions. In some examples, C2C prediction engine 102 optimizes by considering bottlenecks, redundancies, and delays in the workflow and can include removing unnecessary steps or automating certain tasks to streamline processing or remove an inefficient step. Optimization may include negotiating better terms with suppliers, leveraging economies of scale, adopting cost-effective procurement strategies, and/or the like. Optimization may include time reduction to complete the C2C process. For example, by shortening cycle times, expediting approvals, and reducing delays, faster execution of contracts can lead to quicker access to goods or services. In some non-limiting embodiments or aspects, potential risks associated with the process can be used to identify and eliminate vulnerabilities, compliance issues, other risk factors that could impact the success of the C2C cycle, and/or the like. In some non-limiting embodiments or aspects, C2C prediction engine 102 tracks performance of suppliers and vendors included in the process. This performance information may be used to identify high-performing suppliers and prioritize concepts to strengthen relationships with them (e.g., based on scores, prioritization, etc.).

In some non-limiting embodiments or aspects, C2C prediction engine 102 provides data analytics to gain insights into the performance of the C2C process, such as key performance indicators (KPIs) to identify trends, patterns, and areas that require attention.

In some non-limiting embodiments or aspects, C2C prediction engine 102 benchmarks to identify areas where the process can be enhanced to achieve a competitive advantage. Benchmarking compares the performance of the C2C process against industry benchmarks or best practices.

In some non-limiting embodiments or aspects, at step 214 workflow 200 includes case closure. Case closure includes the process of formally concluding or completing a specific case, issue, project, request, or customer interaction. Case closure signifies that each necessary action, task, and resolution related to the case has been accomplished and that the case no longer requires active attention or further follow-up. In some examples, validation or an objective confirmation is transmitted or stored in association with one or more case requirements for case closure to be provided once conditions have been met. In other examples, reports and updates are generated to track the status and outcomes. In other examples, a feedback loop is implemented that allows for continuous improvement of the matching process by analyzing an effectiveness of the rules, criteria, or thresholds and adjusting them as needed.

In some non-limiting embodiments or aspects, the matching process aims to align the operating parameters (data-driven factors) with the critical parameters (strategic and significant factors) to make informed contract and procurement decisions that meet the organization's goals, compliance standards, and risk tolerance. Automated systems, AI-based tools, and procurement inference engines may significantly streamline this process, safeguarding consistency and efficiency.

In some non-limiting embodiments or aspects, a healthcare contract and a sourcing system are designed to manage healthcare agreements with an integrated contract manager that automates contract management. This system is equipped to monitor agreements with pending expirations associated with specific conditions, including commodities, service types, contract groups, spending thresholds, date ranges, expiration dates, or department budgets. The contract management server, linked to a computer program product, communicates renewal requests to approvers. Upon approval, it triggers the creation of a requisition in the healthcare resource planning system. Additionally, the system incorporates a healthcare supply chain system that handles supply information and external supplier interactions. It automatically generates call-to-action messages for suppliers to submit new or revised bids, monitors incoming proposals, escalates actions if no response is received, and initiates steps for creating new contracts based on supplier proposals. Finally, it links requisition approvals to the closing of cases in the healthcare supply chain system.

Within this healthcare contract and sourcing system, agreements are categorized as new, renewal, renegotiated, or terminated, and this contract type guides the communication processes involved. These processes encompass actions such as requesting renewal approvals from receiving departments, submitting updated proposals, and notifying suppliers to initiate new, renewal, renegotiated, or termination processes.

In some non-limiting embodiments or aspects, healthcare contract and sourcing system generates URLs to create requisitions and cases for sourcing events and linking them to agreements or new requisitions based on event types. Moreover, it determines contract leaders who identify approving departments and leaders. The system is equipped to initiate sourcing events if an agreement is set to expire within 90 days.

In some non-limiting embodiments or aspects, to diagnose call-to-actions, the healthcare contract and sourcing system uses predetermined data elements, including contract expiration, contract type, the nature of the call-to-action, or auto call-to-action and task assignment.

The healthcare contract and sourcing system also prioritizes cases based on criteria such as time to completion before expiration, supplier performance indicators, or commodity type, resulting in a well-organized sourcing process.

In some non-limiting embodiments or aspects, healthcare contract and sourcing system initiates sourcing events that involves calculating return on investment, prioritizing events by value, comparing bid proposals, ranking bids based on value, calculating spend history for renewals, and identifying alternate suppliers for expanded supplier lists.

The healthcare contract and sourcing system are designed to diagnose approved requisitions by commodity type and determine the auto creation of cases based on commodities or volume.

In a computer-implemented method for healthcare contract and sourcing generating sourcing events, records with pending expirations are obtained and monitored. Conditions for initiating changes to agreements are determined, and renewal requests are communicated to approvers. Upon approval, requisitions are created. In parallel, supply information is transmitted within a healthcare supply chain system, which automatically generates call-to-action messages for external suppliers. The system monitors incoming proposals, escalates actions if necessary, and initiates steps for creating new contracts based on supplier proposals. This process involves creating contract cases, approving funds, and transmitting purchase orders.

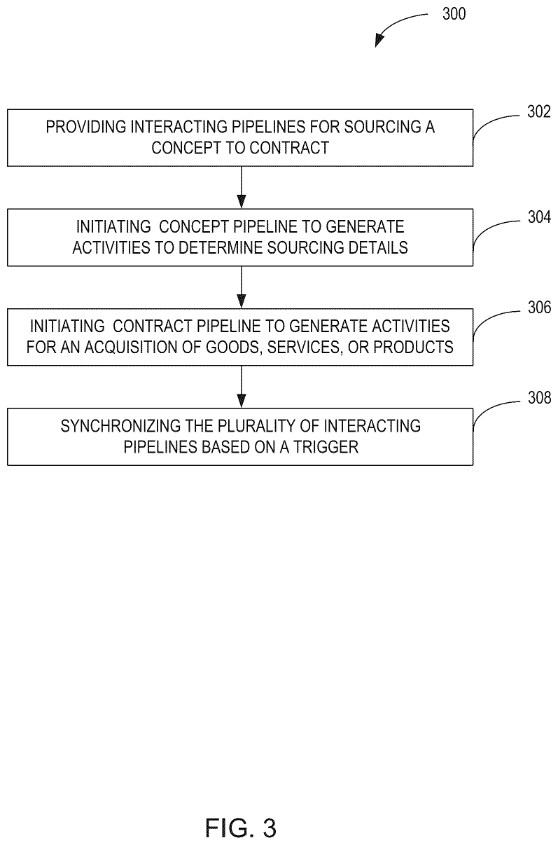

Referring now to FIG. 3, FIG. 3 is a step diagram of a non-limiting embodiment of process 300 for automating exception processing across each account in a general ledger having a plurality of accounts. In some non-limiting embodiments, one or more of the steps of process 300 are performed (e.g., completely, partially, etc.) by computing environment 100 and may include one or more computer systems. For example, computing environment 100 may include C2C prediction engine 102 (e.g., one or more devices of C2C prediction engine 102, one or more devices of C2C prediction engine 402, etc.), resource planning system 104 (e.g., one or more devices of resource planning system 104), data visualization system 106 (e.g., one or more devices of data visualization system 106), user computing device 112 (e.g., one or more devices of user computing device 112), external computer system 118 (e.g., one or more devices of external computer system 118) and a supplier sales automation 120 (e.g., one or more devices of supplier sales automation 120).

As shown in FIG. 3, at step 302, process 300 includes, providing a plurality of interacting pipelines for sourcing a C2C, including a concept pipeline and a contract pipeline. For example, C2C prediction engine 102 provides a plurality of interacting pipelines for sourcing a concept to a contract, including a concept pipeline and a contract pipeline.

In some non-limiting embodiments or aspects, C2C prediction engine 102 (e.g., healthcare exception management system, etc.) comprises a healthcare resource planning system with an integrated general ledger for automating order processing across various accounts. The C2C prediction server monitors records in these accounts, intercepting invoices that define obligations for healthcare items associated with transaction records triggered by item movement within the healthcare supply chain. This movement generates purchase orders in account records. The healthcare supply chain system features structured communication networks for distributing healthcare supplies.

In some non-limiting embodiments or aspects, the C2C prediction engine 102 executes processes through instructions stored on a computer-usable medium. This healthcare resource planning system incorporates an integrated general ledger that functions with precision to automate the task of processing orders across diverse accounts. Within the healthcare supply chain, transaction records related to the movement of healthcare items trigger obligations outlined in invoices. The exception prediction server monitors these accounts, intercepting these invoices and ensuring the seamless flow of healthcare items. The healthcare supply chain system is fortified with structured communication networks, facilitating the efficient distribution of healthcare supplies.

In some non-limiting embodiments or aspects, C2C prediction engine 102 provides a C2C prediction engine for generating scores. C2C prediction engine 102 takes on the pivotal role of a C2C prediction engine. It is specifically engineered to generate scores that hold significant importance in the decision-making. These scores are not just numeric values; but also represent a quantitative measure of the concepts under consideration.

In some non-limiting embodiments or aspects, C2C prediction engine 402 scores one or more concepts as part of an assessment process to streamline decision-making and provide a quantitative measurement of the concept.

In some non-limiting embodiments or aspects, C2C prediction engine 402 prioritizes the one or more concepts based on a score for at least one of a viability of a concept, an alignment of a concept with at least one organizational goal, or a potential impact of a concept, and each score provides a quantitative measure to compare different concepts and to guide decision-makers in selecting a concept to proceed. For example, the prioritization rests on several key factors, including the concept's viability, its alignment with the organizational goals, and its potential impact. Each of these factors is assigned a score, creating a structured and objective basis for comparison.

In some non-limiting embodiments or aspects, C2C prediction engine 102 obtains a set of evaluation criteria and key performance indicators (KPIs) that align with one or more objectives related to factors like cost-effectiveness, strategic alignment, feasibility, and potential impact.

In some non-limiting embodiments or aspects, C2C prediction engine 402 assigns each criterion from the set of evaluation criteria a weight to reflect (e.g., describe, etc.) its relative importance, wherein financial viability might be weighted more heavily than other criteria and a scores weighting reflects a priority to the at least one organization goal. For example, C2C prediction engine 102 obtains a set of evaluation criteria and key performance indicators (KPIs) programmed and/or configured to mesh (e.g., harmonize, etc.) with the overall objectives. These objectives encompass elements, such as cost-effectiveness, strategic alignment, feasibility, potential impact, and/or the like.

In some non-limiting embodiments or aspects, C2C prediction engine 102 assesses one or more concepts against each criterion.

In some non-limiting embodiments or aspects, C2C prediction engine 102 assigns a plurality of numerical scores related to an alignment of the concept for each criterion. For example, C2C prediction engine 102 assigns weights to each of them. For instance, financial viability might be endowed with a heavier weight compared to other criteria. This weighting is executed in alignment with the organization's goals and priorities. C2C prediction engine 102 undertakes a comprehensive assessment of the concepts in relation to each of these criteria. The engine assigns numerical scores, and these scores represent the degree of alignment between the concept and the specific criterion.

In some non-limiting embodiments or aspects, C2C prediction engine 102 normalizes the plurality of numerical scores so that different criterion are on a common scale.

In some non-limiting embodiments or aspects, C2C prediction engine 102 generates a total concept score comprising each of the plurality of numerical scores to quantify an overall quality of the concept. The summation of these numerical scores yields the total concept score, an all-encompassing quantification of the concept's overall quality. The total concept score is an objective and unbiased representation, minimizing subjectivity in the evaluation process.

In some non-limiting embodiments or aspects, each score reduces bias and subjectivity assessing one or more concepts against each criterion by providing an objective basis for comparing different ideas or proposals related to each concept. One of skill in the art would understand that the introduction of this scoring system introduces transparency to the evaluation process and empowers stakeholders by offering insight into the concepts that are either embraced or declined. Concepts with higher scores are fast-tracked, accelerating them through the interconnected interactive pipelines. This streamlined execution safeguards that resources are channeled to concepts with the greatest potential for success, preventing over allocation and optimizing the deployment of resources.

In some non-limiting embodiments or aspects, the total concept score allows decision-makers to prioritize concepts. Concepts with higher scores are considered more promising and can be fast-tracked for further development.

In some non-limiting embodiments or aspects, resources are directed to concepts with a greatest potential for success to prevent resources to limit over allocation of resources.

In some non-limiting embodiments or aspects, concepts are evaluated against predefined criteria to identify potential risks and challenges and take appropriate actions to mitigate these risks or select alternative concepts.

In some non-limiting embodiments or aspects, a scoring process selects concepts which align with an organization's strategic goals and priorities.

In some non-limiting embodiments or aspects, concepts that score high move through the plurality of the interacting pipelines more quickly than those that score lower for a streamlined execution of initiatives.

In some non-limiting embodiments or aspects, a scoring system provides transparency to stakeholders, providing insight into certain concepts that are chosen or rejected to enhance buy-in or support for selected concepts. Additionally, the scoring process serves as a safeguard against potential risks and challenges. For example, selected concepts seamlessly align with the organization's strategic goals and priorities, thereby enhancing the overall effectiveness of initiatives. The impact of this scoring system is felt throughout the entire process, with promising concepts moving swiftly, while careful consideration is given to those with lower scores. Ultimately, the objective is to enhance the decision-making process and increase buy-in and support for selected concepts.

As shown in FIG. 3, at step 304, process 300 includes initiating the concept pipeline to generate activities for guiding organizational users to determine sourcing details associated with an organizational opportunity or need. For example, C2C prediction engine 102 initiates the concept pipeline to generate activities for guiding organizational users to determine sourcing details associated with an organizational opportunity or need.

In some non-limiting embodiments or aspects, this initiation process sets in motion a well-designed series of activities. These activities play a crucial role in guiding organizational users in determining the intricate sourcing details related to a distinct organizational opportunity or need.

In some non-limiting embodiments or aspects, C2C prediction engine 102 activates the concept pipeline. Activating the concept pipeline, in turn, generates a sequence of activities that are instrumental in shaping the trajectory of the organizational opportunity or need. These activities play a pivotal role in enhancing the decision-making process, ensuring that all the sourcing details are meticulously examined.

Moreover, the synchronization of the multiple interacting pipelines is integral to the overall operation. The synchronization relies on the information gathered by the concept pipeline. This information is a valuable asset, containing critical insights into a range of elements such as supplier evaluations, vendor selections, procurement requirements, and/or the like. This data is thoughtfully transferred to the contract pipeline for the subsequent phases, specifically the drafting and negotiation stages.

In some non-limiting embodiments or aspects, the synchronization process is a seamless flow of information and insights that ensures the most effective progression from the conceptualization of ideas to their contractual realization. The concept pipeline stands as the wellspring of essential data, forming the foundation upon which the strategic decisions are made in the contract pipeline.

In some non-limiting embodiments or aspects, the handover of supplier evaluations, vendor selections, and procurement requirements expedites the subsequent phases but also guarantees that these phases are deeply rooted in a foundation of well-informed decision-making.

The functions of the concept pipeline are integral to managing the sourcing of new and existing products or services. They include aspects such as workload management, case tracking, escalation, and reporting, which facilitate a systematic approach to sourcing. Additionally, the concept pipeline automates the creation of cases, facilitating the initiation of sourcing events, internal committee formulation, scope development, and drafting sourcing documents or contracts.

Within the concept pipeline, concept development is a key function. For example, it includes making decisions related to sourcing, assessing new initiative requests, allocating funds, and initiating requests for quotes or information. Simultaneously, the pipeline allows for the development of detailed scopes of work (SOW), involving subject matter experts, milestones, and defining what is in or out of the scope.

In some non-limiting embodiments or aspects, the concept pipeline includes the formulation of committees, which involves selecting key stakeholders and addressing potential conflicts of interest. It also aids in developing the scope of the work, leveraging subject matter experts, defining milestones, deliverables, and determining whether elements are in or out of scope. Moreover, the pipeline supports the drafting of sourcing documents, involving stakeholders, setting evaluation criteria, determining weightings, specifying technical requirements, and utilizing templates for sourcing documents and contracts.

In some non-limiting embodiments or aspects, C2C prediction engine 102 evaluates concepts and functions for sourcing document approval and deployment. This involves the negotiation, awarding of contracts, issuing purchase orders, updating ERP systems, deploying call-to-actions as needed, and monitoring responses, with an option to auto-escalate when necessary.

In some non-limiting embodiments or aspects, the final function in the concept pipeline is evaluating the concept. It includes convening a selection committee, hosting presentations from vendors and stakeholders, conducting evaluation scoring, and overseeing the construction phase. This function is essential for ensuring that concepts move smoothly through the sourcing process, with thorough assessments.

In this way, a comprehensive set of functions so that the concept pipeline is not only the catalyst for sourcing endeavors but also a well-structured and data-driven facilitator of every step in the process. It serves as the pipeline for successful sourcing within the organization.

In some non-limiting embodiments or aspects, synchronizing the plurality of interacting pipelines based on the trigger further comprises information gathered by the concept pipeline and includes at least one of supplier evaluations, vendor selections, or procurement requirements and is transferred to the contract pipeline for drafting and negotiating.

As shown in FIG. 3, at step 306, process 300 includes initiating the contract pipeline to generate activities capable of defining one or more terms, conditions, or legal requirements of the contract, for an acquisition of goods, services, or products related to the organizational opportunity or requirement. For example, C2C prediction engine 102 initiates the contract pipeline to generate activities capable of defining one or more terms, conditions, or legal requirements of the contract, for an acquisition of goods, services, or products related to the organizational opportunity or requirement.

In some non-limiting embodiments or aspects, the concept pipeline and the contract pipeline run concurrently while at least one activation is made between the interacting pipelines to expedite a procurement.

In some non-limiting embodiments or aspects, initiation of the contract pipeline sets in motion a series of activities capable of defining one or more terms, conditions, or legal requirements of the contract. These activities are focused on acquisitions of goods, services, or products directly related to the organizational opportunity or requirement. For example, C2C prediction engine 102 initiates the contract pipeline to generate these contract-related activities.

Further, C2C prediction engine 102 initiates the simultaneous operation of concept and contract pipelines. In some examples, the concept pipeline and the contract pipeline operate concurrently, allowing for a seamless flow of activities between the two. This concurrent operation of the procurement process causes the various stages of sourcing and contract development to progress without unnecessary delays.

In some non-limiting embodiments or aspects, the contract pipeline encompasses a wide array of functions for contract development. These functions are essential for defining the terms, conditions, and legal requirements of the contract. For example, the functions include a requisition phase. Requisition involves a series of functions such as assessing the need for a new initiative, conducting capital review committee evaluations, considering construction requirements, securing the necessary funding, and/or the like.

In some non-limiting embodiments or aspects, stakeholders may be involved. The stakeholders may make decisions regarding training and development, bio-medical considerations, strategic planning for high-value contracts, construction, benchmarking, communication and/or the like.

In some non-limiting embodiments or aspects, the contract pipeline encompasses the engagement of stakeholders, the development of contract scope, the creation of a scope of work, and the use of contract templates or amendments to existing contracts. Communication with all relevant parties is essential to ensure clarity and alignment.

In some non-limiting embodiments or aspects, the contract pipeline encompasses negotiating contract documents. Negotiation is a critical part of the contract development process. Stakeholders, vendors, various teams, and/or the like are engaged. Functions such as training, deployment, innovation, legal considerations, privacy, risk management, reviewing and revising contract terms (redlines), pricing discussions, other negotiation-related aspects, and/or the like are part of this stage.

In some non-limiting embodiments or aspects, the contract pipeline prompts stakeholders and vendors in the final steps of awarding contracts to selected vendors. In some non-limiting embodiments or aspects, the contract pipeline encompasses contract execution. This phase includes critical functions like creating work orders, issuing purchase orders, engaging with vendors, and ensuring that all necessary documentation is stored securely for document management.

In some non-limiting embodiments or aspects, the contract pipeline ensures that creation, negotiation, and execution of contracts are streamlined and efficient, providing a comprehensive approach to the procurement process. These functions within the contract pipeline are instrumental in defining, negotiating, and executing contracts, enabling the organization to effectively acquire goods, services, or products.

As shown in FIG. 3, at step 308, process 300 includes synchronizing the plurality of interacting pipelines based on a trigger. For example, C2C prediction engine 402 synchronizes the plurality of interacting pipelines based on a trigger.

In some non-limiting embodiments or aspects, synchronizing the plurality of interacting pipelines based on the trigger further comprises detecting a trigger. For example, a specific event, condition, or criteria may be identified within the sourcing process. When this trigger is detected, it serves as a signal that certain actions must be taken to move the process forward. This detection could relate to various aspects within sourcing, such as reaching a specific stage in the concept pipeline, receiving critical data, or meeting predefined criteria. Essentially, it is the mechanism that signifies that it is time to proceed with the contract-related activities.

In some non-limiting embodiments or aspects, synchronizing the plurality of interacting pipelines based on the trigger further comprises in response to the trigger, activating a signal to initiate one or more activities in the contract pipeline. The synchronization process goes a step further by not only detecting a trigger but also responding to it. When the trigger is identified, a signal is activated. This signal is essentially a call to action within the contract pipeline. It triggers the initiation of one or more activities within the contract pipeline. For example, activities are designed to set the contractual aspects in motion, encompassing activities such as defining terms, conditions, legal requirements, and all other contract-related tasks. In some examples, a dynamic and responsive process ensures timely progress in the acquisition of goods, services, or products.

In some non-limiting embodiments or aspects, synchronizing the plurality of interacting pipelines based on the trigger further comprises in response to the trigger, activating a signal to initiate one or more activities in the contract pipeline. For example, the synchronization of interacting pipelines also includes the coordination of activities within the contract pipeline. Once the trigger is detected, a signal is activated. In response to this signal, one or more activities within the contract pipeline are initiated. These activities are carefully orchestrated to ensure a well-structured and organized progression toward contract development. The synchronization process ensures that these activities are conducted in a systematic and coordinated manner, guaranteeing that the contractual aspects are efficiently defined, reviewed, and negotiated, all in alignment with the broader sourcing process.

In some non-limiting embodiments or aspects, a trigger comprises budget approval. As an example, in the concept pipeline, one of the triggers could be obtaining budget approval for a particular sourcing initiative. Once the budget is approved, this serves as a critical trigger for moving forward in the sourcing process.

As an example, in response to budget approval, a signal is activated to initiate automatically contract-related activities. Contract-related activities include defining the budget allocation within the contract, negotiating pricing terms, and aligning the contract with the approved budget.

Once the trigger is detected, the contract pipeline responds with coordinated activities, such as creating relevant sections in the contract document or specifying terms in alignment with the trigger. This ensures a seamless transition from the sourcing concept to the contract development phase. For example, coordinated activities within the contract pipeline may involve creating a budget allocation section in the contract document, conducting pricing negotiations, and ensuring that the contract aligns with the financial parameters set in the budget approval.

In some non-limiting embodiments or aspects, a trigger comprises a vendor selection. In the concept pipeline, C2C prediction engine 102 activates the trigger for selection of a vendor after a rigorous evaluation process. Once a vendor is selected, this becomes a trigger for moving into the contract phase. In such an example, synchronization may take place in response to vendor selection. For example, C2C prediction engine 102 activates a signal that is activated to initiate activities in the contract pipeline. These activities involve drafting the specific terms and conditions of the contract with the chosen vendor. In such an example, coordinated activities within the contract pipeline include crafting a detailed contract document, specifying delivery schedules, quality standards, and pricing agreements, all in coordination with the vendor's capabilities and the organization's needs. In this way, once the trigger is detected, the contract pipeline responds with coordinated activities, such as creating relevant sections in the contract document or specifying terms in alignment with the trigger. This ensures a seamless transition from the sourcing concept to the contract development phase.

In some non-limiting embodiments or aspects, synchronizing the plurality of interacting pipelines based on the trigger further comprises in response to the trigger, activating a signal to initiate one or more activities in the contract pipeline. For example, when a trigger is detected, such as obtaining budget approval, activating a signal ensures the timely initiation of activities in the contract pipeline. This includes creating sections in the contract document related to budget allocation, pricing negotiations, and alignment with the approved budget.

In some non-limiting embodiments or aspects, synchronizing the plurality of interacting pipelines based on the trigger further comprises in response to the trigger, activating a signal to initiate one or more activities in the contract pipeline.

In some non-limiting embodiments or aspects, synchronizing the plurality of interacting pipelines based on the trigger further comprises at least one activation generated (e.g., made, etc.) between the interacting pipelines to expedite a procurement. In specific situations, activations between the concept pipeline and contract pipeline expedite the procurement process. For instance, when C2C prediction engine 102 identifies a conceptual product or service need, this triggers the concept pipeline, while simultaneously initiating contract drafting and vendor selection in the contract pipeline. This simultaneous activation expedites procurement by reducing time gaps.

In some non-limiting embodiments or aspects, C2C prediction engine 102 identifies a need for a conceptual product or service.

In some non-limiting embodiments or aspects, C2C prediction engine 102 creates a request for the conceptual product or service.

In some non-limiting embodiments or aspects, C2C prediction engine 102 obtains one or more approvals that are required within the concept pipeline.

In some non-limiting embodiments or aspects, C2C prediction engine 102 operates the contract pipeline to approve a requisition.

In some non-limiting embodiments or aspects, C2C prediction engine 102 operates the contract pipeline to contract drafting.

In some non-limiting embodiments or aspects, C2C prediction engine 102 operates the contract pipeline to award contracts.

In some non-limiting embodiments or aspects, the trigger occurs at a stage in the concept pipeline to ensure that activities associated with development of the concept align with development of contract terms or requirements. A trigger occurring at a specific stage in the concept pipeline guarantees alignment between concept development and contract requirements. For instance, when a conceptual product or service reaches a stage where a formal contract is essential, the trigger ensures that the concept's development aligns with the necessary contract terms, expediting the transition.

In some non-limiting embodiments or aspects, the trigger occurs at a stage in the concept pipeline to ensure that activities associated with development of the concept align with development of contract terms or requirements.

In some non-limiting embodiments or aspects, the trigger includes a transition trigger. As an example, the concept progresses to a point where a formal contract is required (e.g., needed, etc.) to formalize an agreement between the parties. This trigger signifies a point in the concept's progression where a formal contract is required to formalize an agreement between parties, synchronizing both pipelines for contract development.

In some non-limiting embodiments or aspects, the trigger includes an awards trigger, wherein one or more vendors are awarded the contract. When one or more vendors are awarded the contract based on evaluations in the concept pipeline, it acts as a trigger for the contract pipeline. For example, awards trigger for procurement processes may involve vendor awards.

In some non-limiting embodiments or aspects, the trigger includes a decision trigger. For example, a sourcing decision is generated. As an example, C2C prediction engine 102 generates sourcing decisions within the concept pipeline to serve as triggers, signifying the need for contract development. For example, when the concept is approved for procurement, the contract pipeline is initiated.

In some non-limiting embodiments or aspects, the trigger includes a contract trigger. For example, the trigger can also be a decision point when it is determined that a formal contract is necessary for the procurement process to move forward.

In some non-limiting embodiments or aspects, the trigger includes a communication trigger. For example, synchronization between the plurality of interacting pipelines includes communication of one or more critical details, requirements, or information related to a procurement decision, a selected vendor, one or more terms, or one or more conditions. When synchronizing the pipelines, a communication trigger is essential. It includes the exchange of critical details, requirements, and information related to procurement decisions, selected vendors, contract terms, and conditions, ensuring that both pipelines have the essential information they need for a streamlined process.

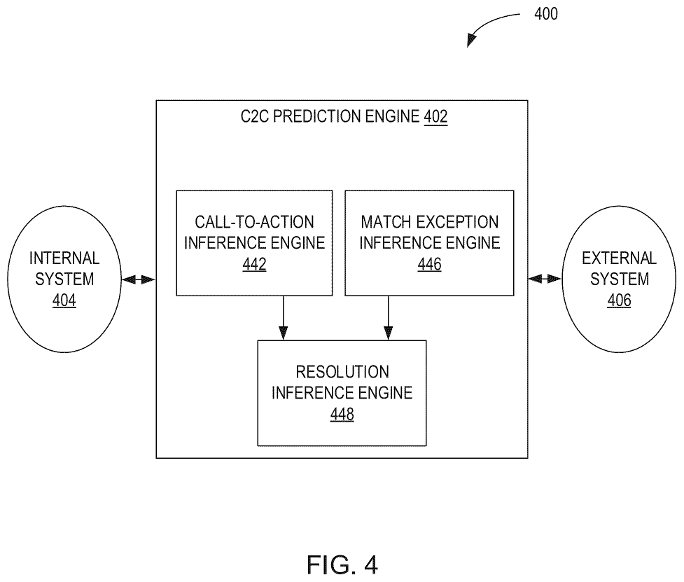

FIG. 4 shows an illustrative computing environment 400 for performing enhanced exception processing using cognitive automation tools in accordance with one or more example embodiments. With reference to FIG. 4, computing environment 400 may include one or more computer systems. For example, computing environment 400 may include C2C prediction engine 402, internal system 404, external system 406, call-to-action inference engine 442, match exception inference engine 446, and resolution inference engine 448. In some non-limiting embodiments, one or more of the components 400 are performed (e.g., completely, partially, etc.) by C2C prediction engine 402 (e.g., one or more devices of C2C prediction engine 402, one or more processors of the C2C prediction engine, one or more CPU or GPU of C2C prediction engine, etc.), resource planning system 104 (e.g., one or more devices of exception resource planning system 104), data visualization system 106 (e.g., one or more devices of data visualization system 106), user computing device 112 (e.g., one or more devices of user computing device 112), external computer system 118 (e.g., one or more devices of external computer system 118), and supplier sales automation 120 (e.g., one or more devices of supplier sales automation 120). For example, in some non-limiting embodiments or aspects, internal system 404 includes resource planning system 104 such as ERP systems from PeopleSoft, Oracle, Epicor, SAP, and/or the like. In some examples, external system 406 includes supplier sales automation system 120, Salesforce.com, NetSuite, PipeDrive, and/or the like. Internal system 404 and external system 406 may be interconnected by the C2C prediction engine 402 to optimize the supply chain.

In some non-limiting embodiments or aspects, call-to-action inference engine 442 transforms predictions generated by C2C prediction engine 402 to determine appropriate call-to-actions. For example, when C2C prediction engine 402 identifies a specific exception like “voucher's extended price exceeds the purchase order's extended price,” call-to-action inference engine 442 may activate actions like reviewing the price discrepancy, investigating further, possibly alerting relevant personnel, and/or the like. In some non-limiting embodiments or aspects, call-to-action inference engine 442 is trained to generate a call-to-action.

In some non-limiting embodiments or aspects, a mismatch between voucher and PO prices is detected within tolerance limits. In such an example, call-to-action inference engine 442 generates a call in cases where the price percentage tolerance for example may not equate to zero, and the converted voucher price may be beyond the calculated PO price range. In such an example, call-to-action inference engine 442 activates a call for a thorough review of pricing agreements and terms. Likewise, call-to-action inference engine 442 determines call-to-actions for scenarios where unit price tolerance deviations and anomalies involving RTV or Credit Adjustment Amount exceed the PO Matched Amount. Call-to-action inference engine 442 activate a call including one or more relevant (e.g., related, etc.) recommendations for resolution.

In some non-limiting embodiments or aspects, when the total vouchered quantity surpasses the allowed quantity considering both PO quantity and over-receiving allowance, call-to-action inference engine 442 may activate a call for adjusting the quantities, investigating over-receiving reasons, or verifying purchase orders. In some examples, call-to-action inference engine 442 activates a call for situations where receiving percentage tolerance deviations lead to excess vouchered quantity.

In some non-limiting embodiments or aspects, call-to-action inference engine 442 predicts discrepancies (e.g., exceptions, etc.) in total vouchered amount exceeding the PO amount, call-to-action inference engine 442 might activate a call for verifying invoicing and pricing.

In some non-limiting embodiments or aspects, call-to-action inference engine 442 predicts pricing discrepancies. For example, when pricing mismatches are identified between the initial concept and the formal contract, call-to-action inference engine 442 may initiate a call for a comprehensive review of these pricing disparities. In such an example, call-to-action may include conducting a thorough examination of the pricing components to determine the root causes of the discrepancies. The goal is to align the contract terms with the original concept and ensure pricing accuracy.

In some non-limiting embodiments or aspects, call-to-action inference engine 442 negotiates contract terms. For example, if discrepancies emerge in the contract terms compared to the initial concept, the call-to-action inference engine plays a pivotal role in initiating contract renegotiations. It may activate calls for negotiations with relevant parties, such as suppliers or stakeholders, to reconcile the terms and reach a consensus that aligns the contract with the initial concept.

In some non-limiting embodiments or aspects, call-to-action inference engine 442 generates an alert to relevant stakeholders. For example, when variations between the concept and the contract are detected, call-to-action inference engine 442 is capable of activating calls to alert pertinent stakeholders. In some examples, the alerts serve to notify individuals or teams involved about the identified discrepancies, ensuring that everyone is informed and can take appropriate actions.

In some non-limiting embodiments or aspects, call-to-action inference engine 442 verifies purchase orders. For example, when deviations are determined (e.g., exist, etc.) between the purchase orders and the original concept, call-to-action inference engine 442 may initiate calls to verify and align these purchase orders with the agreed-upon contract terms. This verification process ensures that the purchase orders accurately reflect the contracted requirements.

In some non-limiting embodiments or aspects, call-to-action inference engine 442 investigates price deviations. For example, for scenarios where price discrepancies are observed, call-to-action inference engine 442 activates calls to investigate the underlying causes of these deviations. Call-to-action inference engine 442 can generate a comprehensive analysis of market prices, supplier agreements, and other factors contributing to the pricing differences, ensuring transparency in pricing matters.

In some non-limiting embodiments or aspects, call-to-action inference engine 442 may adjust quantities. For example, call-to-action inference engine 442 may detect discrepancies in quantities between the contract and the initial concept. Call-to-action inference engine 442 may activate calls for quantity adjustments. These actions focus on bringing the contracted quantities in line with the actual requirements, promoting efficient resource management.

In some non-limiting embodiments or aspects, call-to-action inference engine 442 reevaluates supplier agreements. For example, when discrepancies are identified in supplier agreements compared to the concept, call-to-action inference engine 442 may activate calls to reevaluate these agreements. In such an example, call-to-action inference engine 442 may call for a comprehensive assessment of the agreements to ensure that they align with the contract terms and the concept's expectations.

In some non-limiting embodiments or aspects, call-to-action inference engine 442 may reconcile payment terms. For example, call-to-action inference engine 442 activates calls to reconcile payment term differences when variations between the concept and the contract arise. In some examples, during the reconciliation process call-to-action inference engine 442 determines that the payment terms in the contract are consistent with the original concept, fostering financial clarity.

In some non-limiting embodiments or aspects, call-to-action inference engine 442 monitors performance. For example, call-to-action inference engine 442 maintains continuous monitoring of supplier performance to uphold contractual agreements. Call-to-action inference engine 442 may initiate calls to monitor supplier performance, ensuring that it aligns with the terms outlined in the contract. In this way, monitoring helps maintain consistent and reliable supplier performance.

In some non-limiting embodiments or aspects, call-to-action inference engine 442 validates compliance. For example, call-to-action inference engine 442 verifies compliance with regulatory requirements and internal policies that are critical in the C2C process. Call-to-action inference engine 442 may activate calls to validate compliance, ensuring that both the concept and the contract adhere to necessary standards, rules, and regulations. In this way, call-to-action inference engine 442 promotes legal and ethical adherence in the supply chain.

In some non-limiting embodiments or aspects, match exception inference engine 446 may obtain observed match exceptions to provide further insights into other match exceptions. For example, based on C2C prediction engine 402 predicting that a voucher's extended price exceeds a threshold tolerance, match exception inference engine 446 may obtain a detailed breakdown (e.g., a specification, etc.) of how the calculations were made, showcasing the extent of the discrepancy and the parameters that triggered the prediction.

In some non-limiting embodiments or aspects, resolution inference engine 448 may provide automated suggestions for resolving the predicted exceptions. Resolution inference engine 448 may obtain historical or observed data and historical or observed resolutions for learning potential solutions for resolving match exceptions. For example, if a price discrepancy is predicted, resolution inference engine 448 could recommend initiating a price negotiation with the supplier, verifying the data input, or recalculating the tolerances.

The engines (e.g., collectively, exception processing engine 402, call-to-action inference engine 442, match exception inference engine 446, and resolution inference engine 448) form an integrated system that enhances item processing, automates decision-making, and optimizes distribution within the healthcare supply chain.

In some non-limiting embodiments or aspects, C2C engine 402 (e.g., as well as engines 442, 446, 448) utilize machine learning techniques to analyze historical data, identify patterns, and generate prediction models tailored to different accounts, suppliers, or transactions. Engines 402 (e.g., and engines 442, 446, 448) apply supervised and unsupervised learning to predict exceptions and inaccurate activities within the healthcare supply chain. Engines (e.g., collectively, exception processing engine 402, call-to-action inference engine 442, match exception inference engine 446, and resolution inference engine 448) generate model representations of the predicted exceptions, accounts, payment information, the parties included, and other relevant data to form insights about new observations. In this way, C2C engine 402 (e.g., as well as engines 442, 446, 448) may provide or generate predictive actions and interpretations for enhancing the accuracy of decision-making related to the exceptions. C2C engine 402 (e.g., as well as engines 442, 446, 448) facilitate integration, for example by establishing efficient integration and communication between supply chain systems, improving interactions with enterprise resource systems, database management systems, workflow systems, and sales automation systems. C2C engine 402 (e.g., as well as engines 442, 446, 448) coordinate the transmission of supply information within a call-to-action system for timely and effective communication regarding steps for resolving the exception across the supply chain. The engines may interact with one or more of resource planning systems, data visualization systems, other enterprise systems, and/or the like, to provide seamless (e.g., coordinated, etc.) data exchange and collaboration. The engines may create a dynamic system that not only predicts exceptions but also guides stakeholders, for example, with specified actions for advancing towards appropriately resolving these exceptions.

In some non-limiting embodiments or aspects, a company's C2C prediction engine 402 continually monitors incoming invoices and compares them to the corresponding goods received. It identifies a match exception where the invoice quantity doesn't match the received quantity.

In some non-limiting embodiments or aspects, the inference engine within C2C prediction engine 402 categorizes this match exception as “Receiving-Quantity Mismatch” based on the established patterns and relationships between attributes.

In some non-limiting embodiments or aspects, call-to-action inference engine 442 plays a pivotal role in translating the predicted match exceptions into actionable inferences within the healthcare supply chain. In some examples, the described scenarios include various types of exceptions, such as Price, LTD, Receiving, and PO Status anomalies.

In some non-limiting embodiments or aspects, C2C prediction engine 402 identifies that a voucher's extended price exceeds the purchase order's extended price. In such an example, the extended price tolerance is not equal to zero. In such an example, call-to-action inference engine 442 could activate call-to-actions such as reviewing the price discrepancy, investigating the reason behind the excess amount, alerting relevant personnel or stakeholders.

In some non-limiting embodiments or aspects, a mismatch between voucher and PO prices is detected within tolerance limits. In such an example, call-to-action inference engine 442 generates a call in cases where the price percentage tolerance may not equate to zero, and the converted voucher price may be beyond the calculated PO price range. In such an example, call-to-action inference engine 442 activates a call for a thorough review of pricing agreements and terms. Likewise, call-to-action inference engine 442 determines call-to-actions for scenarios where unit price tolerance deviations and anomalies involving RTV or Credit Adjustment Amount exceed the PO Matched Amount. Call-to-action inference engine 442 activate a call including one or more relevant (e.g., related, etc.) recommendations for resolution.

In some non-limiting embodiments or aspects, when the total vouchered quantity surpasses the allowed quantity considering both PO quantity and over-receiving allowance, call-to-action inference engine 442 may activate a call for adjusting the quantities, investigating over-receiving reasons, or verifying purchase orders. In some examples, call-to-action inference engine 442 activates a call for situations where receiving percentage tolerance deviations lead to excess vouchered quantity.

In some non-limiting embodiments or aspects, call-to-action inference engine 442 predicts discrepancies (e.g., exceptions, etc.) in total vouchered amount exceeding the PO amount, call-to-action inference engine 442 might activate a call for verifying invoicing and pricing.

In some non-limiting embodiments or aspects, call-to-action inference engine 442 generates recommendations for extended price percentage and tolerance deviations, along with activating a call for handling mismatched quantities that could be provided by the engine.

In some non-limiting embodiments or aspects, call-to-action inference engine 442 activates a call based on discrepancies between packing slips on voucher lines and receiver lines. For example, call-to-action inference engine 442 activates a call for comparing the received goods to the associated documentation. When the matching process can't locate receipts for a specific purchase order on the voucher line, call-to-action inference engine 442 activates a call for investigating the status of the missing receipts and assessing the impact on processing.

For voucher line amounts exceeding the combined receiver line amounts, call-to-action inference engine 442 activates a call for reviewing the discrepancy and ensuring accuracy in calculations.

Similarly, for issues with total received quantity exceeding the accepted received quantity, call-to-action inference engine 442 activates a call for reconciling the discrepancies and making necessary adjustments.

In some non-limiting embodiments or aspects, when payment terms, supplier information, or item detail mismatches occur between various documents, call-to-action inference engine 442 activates a call for verifying the accuracy of data and taking corrective actions.

In each example, call-to-action inference engine 442 obtains the predictions, evaluates the implications, and recommends appropriate actions. These recommendations could include investigating further, initiating communications with relevant parties, adjusting quantities, verifying data accuracy, and addressing discrepancies. The engine serves as a valuable tool for efficient decision-making, process optimization, and seamless collaboration across the healthcare supply chain.

Resolution inference engine 448 is configured to obtain historical data (e.g., review features of the historical data as described herein, etc.) and resolutions (e.g., review features of resolved sourcings or contracts as described herein, etc.) to provide automated addressing one or more other identified exceptions. For example, various exception types, including price, ltd, receiving, and PO status anomalies (e.g., exceptions, etc.).

In some non-limiting embodiments or aspects, resolution inference engine 448 may detect a situation where a voucher's extended price exceeds the purchase order's extended price. Resolution inference engine 448 may recommend actions for resolving the discrepancy (e.g., exceptions, etc.).

Resolution inference engine 448 initiates a price negotiation with the supplier. Resolution inference engine 448 verifies the accuracy of data input for both the voucher and the purchase order. Resolution inference engine 448 recalculates the tolerances and compares them with the actual values.

In some non-limiting embodiments or aspects, resolution inference engine 448 amends the contract. For example, resolution inference engine 448 determines

Significant disparities exist between the initial concept and the formal contract. In such an example, resolution inference engine 448 may generate a viable resolution by amending the contract to align it with the original concept. This involves revising and updating the contract terms, conditions, and specifications to accurately reflect the concept.

In some non-limiting embodiments or aspects, resolution inference engine 448 renegotiates terms. In such an example, resolution inference engine 448, when contract terms require adjustments to match the concept, stakeholders may choose to renegotiate the terms with suppliers or other parties involved. This resolution aims to ensure that all parties are in agreement with the terms and conditions outlined in the contract.

In some non-limiting embodiments or aspects, resolution inference engine 448 clarifies ambiguities. In such an example, resolution inference engine 448 determines cases where ambiguities or misunderstandings arise. Resolution inference engine 448 generates, approves, or requests change language clarifying any vague or unclear sections of the contract, and/or the like. In this way, resolution inference engine 448 ensures that all parties have a shared understanding of the terms and expectations.

In some non-limiting embodiments or aspects, resolution inference engine 448 mediates or arbitrates. When disputes between parties hinder the alignment of the contract with the concept, mediation or arbitration can be employed as a resolution. An impartial third party is called in to facilitate discussions and help parties reach a fair and mutually acceptable agreement.

In some non-limiting embodiments or aspects, resolution inference engine 448 reverts to the original concept. In certain situations, it may be appropriate to revert back to the original concept if it is deemed more practical or suitable than the existing contract. In such an example, resolution inference engine 448 abandons the current contract and reinstates the initial concept.

In some non-limiting embodiments or aspects, resolution inference engine 448 implements change orders. For example, resolution inference engine 448 determines that changes are necessary to align the contract with the concept, a resolution can involve the creation and implementation of change orders. In such an example, resolution inference engine 448 implements change orders which document the modifications to the contract and ensure that the changes are formally acknowledged and accepted by all parties.

In some non-limiting embodiments or aspects, resolution inference engine 448 reworks resource allocation. For example, resolution inference engine 448 determines discrepancies that involve resource allocation. In such an example, resolution inference engine 448 may include the reevaluation and adjustment of resource allocation plans to better align with the concept's requirements.

In some non-limiting embodiments or aspects, resolution inference engine 448 aligns supplier agreements. For example, resolution inference engine 448 determines supplier agreements differ from the concept, the resolution may involve aligning these agreements with the concept's expectations. In such an example, resolution inference engine 448 may update supplier contracts or agreements to ensure that they are consistent with the overarching concept.

In some non-limiting embodiments or aspects, resolution inference engine 448 reevaluates payment terms. For example, resolution inference engine 448 determines that payment terms deviate from the concept. In such an example, resolution inference engine 448 provides reevaluation and adjustment of payment terms to better align with the concept and the contractual requirements.

In some non-limiting embodiments or aspects, resolution inference engine 448 enhances quality control. For example, resolution inference engine 448 determines quality discrepancies between the concept and the contract that require a resolution. In such an example, resolution inference engine 448 enhances quality control processes to ensure that the final product or service aligns with the concept's quality standards.

In some non-limiting embodiments or aspects, the total vouchered quantity exceeds the allowed quantity or a vouchered amount surpasses the PO amount. In such an example, resolution inference engine 448 determines that the total vouchered quantity exceeds the allowed quantity or a vouchered amount surpasses the PO amount. The resolution inference engine 448 may offer steps to perform. For example, resolution inference engine 448 activates reviewing the over-receiving allowance and adjusting quantities as necessary.

In some non-limiting embodiments or aspects, resolution inference engine 448 activates a reconciliation of quantities and amounts. Resolution inference engine 448 receives exceptions.

For discrepancies such as packing slip mismatches or issues with identifying receipts, resolution inference engine 448 activates an action for verifying packing slip data and comparing it with the receiver line. In some non-limiting embodiments or aspects, resolution inference engine 448 activates investigating receipt status and locating missing or unmatched receipts.

For PO status exceptions, such as in cases of differences in payment terms codes or supplier information, resolution inference engine 448 may provide recommendations to recipients recommending steps for resolving the exception. For example, resolution inference engine 448 may activate a call for ensuring consistent and accurate information across all related documents. Also, resolution inference engine 448 may activate a call for initiating communication with the relevant parties to resolve discrepancies.

Resolution inference engine 448 may leverage its analysis of historical resolutions to provide context-specific recommendations. For example, if a specific price discrepancy is similar to past cases that were resolved through a certain action, the engine could suggest that action as a potential solution. This process helps streamline decision-making and reduces the time needed to address exceptions.

Match exception inference engine 446 is an integral component designed to enhance the process of determining match exceptions by leveraging predicted exceptions and providing inferences. Operating within the healthcare supply chain, this engine plays a key role in analyzing and understanding the predictions made by C2C prediction engine 402, thus enabling a more informed approach to identifying and handling exceptions. In some examples, scenarios involving Price, LTD, Receiving, and PO Status anomalies, match exception inference engine 446 operate on factors of the exception (e.g., features of the information, etc.).

When C2C prediction engine 402 predicts a particular exception, such as a voucher's extended price exceeding the purchase order's extended price, match exception inference engine 446 responds to a call to provide comprehensive context. For example, match exception inference engine 446 can retrieve a detailed breakdown of the calculations that led to the prediction. In some examples, a breakdown showcases the specific parameters and data points that contributed to the predicted discrepancy. In other examples, it may provide the specific parameters and data points that contributed to a problem associated with the predicted discrepancy. In still other examples, match exception inference engine 446 obtains the underlying factors that triggered the prediction and provide explanation of the extent of the deviation.

In some non-limiting embodiments or aspects, C2C prediction engine 402 utilizes these insights to match the features of the current prediction to historical cases. In some examples, C2C prediction engine 402, by identifying patterns and similarities between past and present situations, may generate (e.g., make, etc.) new predictions based on accumulated knowledge. This capability improves the accuracy of predictions.

In some non-limiting embodiments or aspects, C2C prediction engine 402 may determine one or more price exceptions. As an example, when C2C prediction engine 402 forecasts a situation where a voucher's extended price exceeds the purchase order's extended price, match exception inference engine 446 may display a detailed analysis of how one or more calculations were performed. In some examples, match exception inference engine 446 may also highlight the relevant tolerance thresholds and deviations, such that the information guides users in understanding the factors behind the predicted exception.

Match exception inference engine 446 provides capabilities to leverage historical data and insights for improving the accuracy and relevance of predictions. By continuously learning from past cases (e.g., data or other information associated with past cases, etc.) and adapting to new scenarios, the engine contributes to a more proactive and informed approach to managing match exceptions within the healthcare supply chain.

In some non-limiting embodiments or aspects, match exception inference engine 446 reviews data when predicting exceptions, and places exceptions as they are classified into sub-classes based on root causes. In some examples, by referencing established standard operating procedures (SOPs) created by the contracts and procurement team, resolution inference engine 448 may provide users with actionable insights which align with best practices. For example, call-to-action comms (e.g., communications, messages, requests, instructions, etc.) guide users on how to address unique circumstances represented by each sub-class, thereby ensuring efficient handling of purchase orders and invoices. Moreover, resolution inference engine 448 satisfies a crucial role in improving the healthcare supply chain to promptly and effectively respond to match exceptions while minimizing disruptions.

In some non-limiting embodiments or aspects, C2C prediction engine 402 identifies the appropriate recipients for a specific match exception. In this example, the recipients could include the internal warehouse department responsible for managing received goods and the AP team that handles invoice discrepancies.

In some non-limiting embodiments or aspects, after the match exception is classified and recipients determined, C2C prediction engine 402 activates a call-to-action. This call-to-action is configured to execute each step (e.g., one or more specific steps to be taken to address the “Receiving-Quantity Mismatch” match exception, etc.).

In some non-limiting embodiments or aspects, an automated communication is triggered and sent to one or more designated recipients. For example, C2C prediction engine 402 generates an email automatically and sends it to a warehouse department and the AP team. The email may include information about the match exception and details about the quantity discrepancy (in the example), and includes a link to access relevant documents like the invoice and the receiving report.

In some non-limiting embodiments or aspects, C2C prediction engine 402 communicates to the recipient the automated communication which provides instructions to the recipient with steps for the prescribed action. The steps are programmed or configured to lead to resolution. In such an example, the warehouse team may receive a communication identifying the received goods and/or a request to verify the actual quantity, while the AP team examines the invoice. If the discrepancy is confirmed, the teams are further coordinated by C2C prediction engine 402 for further actions to resolve the issue. For example, instructions are sent for either adjusting the payment or by coordinating with the supplier to correct the invoice.

In some non-limiting embodiments or aspects, communication channels for various types of recipients include organization's internal communication platform, such as a collaboration tool or intranet, for the internal AP department to receive notifications within their work environment. External suppliers could be communicated with through email, while the supply chain management team might use a dedicated supply chain management platform or tool. Warehouse personnel could receive notifications via email and an internal notification system. For requesters or internal departments included in procurement, collaboration tools or internal messaging systems might be used. Management or directors could receive notifications through email or a dedicated executive communication channel. External partners or vendors might access communications through a secure supplier portal. The data visualization team could be informed via internal communication tools or project management platforms. Examples of chosen communication channels include email, internal communication platforms like Slack or Microsoft Teams, messaging apps such as WhatsApp, intranet postings, dedicated supply chain management systems, supplier portals, SMS notifications, automated phone calls, and notifications within business applications. The choice of communication channel depends on recipient preferences, message urgency, match exception nature, and the organization's existing communication infrastructure.

In some non-limiting embodiments or aspects, as the resolution progresses, the status of the match exception may change automatically within the company's system. Depending on the progress, C2C prediction engine 402 may activate follow-up communications to keep relevant parties informed.

In some non-limiting embodiments or aspects, when C2C prediction engine 402 determines the match exception remains unresolved for a certain duration, C2C prediction engine 402 triggers the escalation process described above. For example, if the issue persists for more than a week, C2C prediction engine 402 automatically escalates the case to higher management levels for attention. As an example, C2C prediction engine 402 automatically escalates the case to higher management levels by activating a call-to-action for automated communication which provides instructions to higher management level recipients with steps for the prescribed action, configured to lead to resolution. In this example, the match exception “receiving-quantity mismatch” triggers an automated communication to the appropriate recipients, guiding them on how to address the issues for efficiently resolving the exception. This process minimizes processing and accessing data resources, accelerates exception resolution, and enables accurate collaboration with timely messages among relevant departments.

In some non-limiting embodiments or aspects, “quick invoices” as used herein refer to a category of invoices that the system does not know how to handle automatically. These quick invoices may not be processed through the regular matching workflow because they lack certain information or have characteristics that prevent the system from automatically determining the appropriate actions for them. Instead, they require manual review and intervention by users to be processed correctly.

In some non-limiting embodiments or aspects, quick invoices as referred to herein may not include factors suitable to address situations where the automated matching process cannot determine how to match an invoice with corresponding purchase orders or receiving information accurately. In some examples, match exception inference engine 446 determines an invoice might be categorized as a quick invoice based on the factors. For example, match exception inference engine 446 determines incomplete data, for example, the invoice may have missing or insufficient data fields required for the matching process, such as missing purchase order numbers, vendor details, or other critical information.

In some non-limiting embodiments or aspects, match exception inference engine 446 may determine unrecognized vendors: For example, match exception inference engine 446 determines that the system may not include the vendor information (e.g., in its database, data store 108, etc.) leading to uncertainty about how to process the invoice. In another example, match exception inference engine 446 may predict that the items listed on the invoice may not have corresponding records in the system, making it challenging for the system to automatically match them to existing purchase orders or receipts. In another example, based on non-standard formats, match exception inference engine 446 may predict that some invoices may not follow the standard formats expected by the system, making it difficult for automated algorithms to interpret and match the data accurately.

In some non-limiting embodiments or aspects, match exception inference engine 446 generates, determines and activates a call for quick invoices that require human intervention and cannot be processed automatically through the regular invoice matching workflow due to incomplete or challenging data. The call-to-action is used to ensure accurate and proper handling of invoices that cannot be immediately matched by the system.

Match exception inference engine 446 may identify quick invoices based on specific criteria, such as missing or incomplete data fields, unrecognized vendors, or any other characteristic that indicates that the system does not know how to handle the invoice. Quick invoices may be flagged and separated from the regular invoice processing flow to prevent them from proceeding to matching until further action is taken. The system may generate alerts or notifications to relevant users or teams to review and manually handle these quick invoices.

In some non-limiting embodiments or aspects, the system may analyze the match exception and relevant data to identify potential alternate POs that may resolve the exception. By searching historical data and related transactions, the system can suggest other POs that could be associated with the invoice, thereby offering a possible corrective action.

In some non-limiting embodiments or aspects, C2C prediction engine 402 may provide a user interface or automated functionality for transmitting images to users to review and select the appropriate alternate PO for resolution.

In some non-limiting embodiments or aspects, various technologies such as rules engines, classification engines, and data analysis to implement these steps include a combination of automated processes, user interfaces for manual review and resolution, and communication functionalities to inform users about invoices and facilitate collaboration in handling match exceptions.

In some non-limiting embodiments or aspects, C2C prediction engine 402 is engaged to extract data and identify exceptions stemming from issues within requisition processes. Match exception inference engine 446 may identify exceptions within workflow tasks and approvals. Match exception inference engine 446 facilitates seamless data exchange through data integration, connecting with the internal system and triggering external activities. For example, a call to action for a user to access the supplier database enables the system to retrieve supplier information, ensuring efficient vendor relationship management.

C2C prediction engine 402 engine optimizes the sourcing process, encompassing supplier selection and proposal management. Salesforce's workflow automation capabilities enable the progression of tasks based on predefined rules and conditions.

C2C prediction engine 402 communication interface provides exchange of relevant data and updates between internal and external systems. Inferences and reporting functions within the supply chain to facilitate tracking of sourcing activities and performance metrics.

APIs or middleware establish seamless integration and synchronization of data between internal and external systems. Data exchange functionalities protect the smooth transfer of requisition details, supplier information, and contract-related data. Notifications and alerts guarantee timely communication with stakeholders to prompt necessary actions.

In some non-limiting embodiments or aspects, C2C prediction engine 402 orchestrates the creation of new items for reorder, substitute, restock, or recall by orchestrating parallel pipelines in both the internal and external systems. It adeptly manages enterprise activities through workflow automation and interprets operating parameters in correlation with critical factors. Furthermore, C2C prediction engine 402 diagnoses operating parameters with predefined threshold values, efficiently tailoring responses, communications, or actions based on these correlations. In some examples, predictive capabilities enable actions, while precision in inventory management and the elimination of inaccuracies enhance system effectiveness.

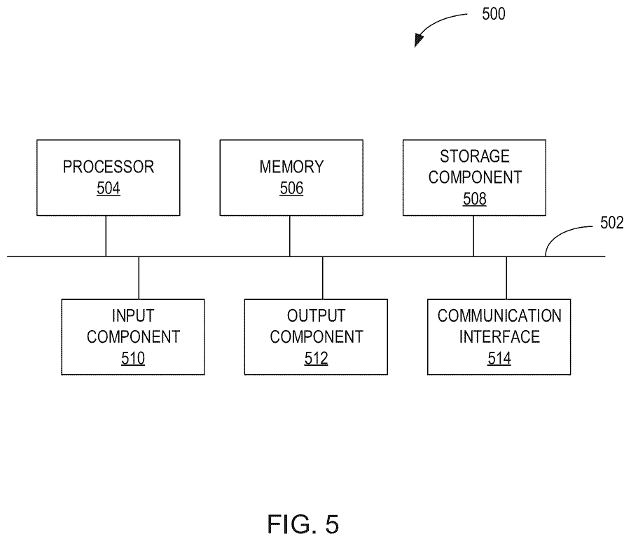

Referring now to FIG. 5, FIG. 5 is a diagram of example components of device 500. Device 500 may correspond to computing environment 100, and may include C2C prediction engine 102 (e.g., one or more devices of C2C prediction engine 102), resource planning system 104 (e.g., one or more devices of exception resource planning system 104), data visualization system 106 (e.g., one or more devices of data visualization system 106), data store 108, user computing device 112 (e.g., one or more devices of user computing device 112), external computer system 118 (e.g., one or more devices of external computer system 118), and supplier sales automation 120 (e.g., one or more devices of supplier sales automation 120).

As shown in FIG. 5, device 500 may include bus 502, processor 504, memory 506, storage component 508, input component 510, output component 512, and communication interface 514. Bus 502 may include a component that permits communication among the components of device 500. In some non-limiting embodiments or aspects, processor 504 may be implemented in hardware, software, or a combination of hardware and software. For example, processor 504 may include a processor (e.g., a central processing unit (CPU), a graphics processing unit (GPU), an accelerated processing unit (APU), and/or the like), a microprocessor, a digital signal processor (DSP), a processing component (e.g., a field-programmable gate array (FPGA), an application-specific integrated circuit (ASIC), etc.), and/or the like, which can be programmed to perform a function. Memory 506 may include random access memory (RAM), read-only memory (ROM), and/or another type of dynamic or static storage device (e.g., flash memory, magnetic memory, optical memory, and/or the like) that stores information and/or instructions for use by processor 504.

Storage component 508 may store information and/or software related to the operation and use of device 500. For example, storage component 508 may include a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, and/or another type of computer-readable medium, along with a corresponding drive.

Input component 510 may include a component that permits device 500 to receive information, such as via user input (e.g., a touch screen display, a keyboard, a keypad, a mouse, a button, a switch, a microphone, a camera, and/or the like). Additionally or alternatively, input component 510 may include a sensor for sensing information (e.g., a global positioning system (GPS) component, an accelerometer, a gyroscope, an actuator, and/or the like). Output component 512 may include a component that provides output information from device 500 (e.g., a display, a speaker, one or more light-emitting diodes (LEDs), and/or the like).

Communication interface 514 may include a transceiver (e.g., a transceiver, a receiver and transmitter that are separate, and/or the like) that enables device 500 to communicate with other devices, such as via a wired connection, a wireless connection, or a combination of wired and wireless connections. Communication interface 514 may permit device 500 to receive information from another device and/or provide information to another device. For example, communication interface 514 may include an Ethernet interface, an optical interface, a coaxial interface, an infrared interface, a radio frequency (RF) interface, a universal serial bus (USB) interface, a Wi-Fi® interface, a Bluetooth® interface, a Zigbee® interface, a cellular network interface, and/or the like.

Device 500 may perform one or more processes described herein. Device 500 may perform these processes based on processor 504 executing software instructions stored by a computer-readable medium, such as memory 506 and/or storage component 508. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 506 and/or storage component 508 from another computer-readable medium or from another device via communication interface 514. When executed, software instructions stored in memory 506 and/or storage component 508 may cause processor 504 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

The number and arrangement of components shown in FIG. 5 are provided as an example. In some non-limiting embodiments or aspects, device 500 may include additional components, fewer components, different components, or differently arranged components than those shown in FIG. 5. Additionally or alternatively, a set of components (e.g., one or more components) of device 500 may perform one or more functions described as being performed by another set of components of device 500.

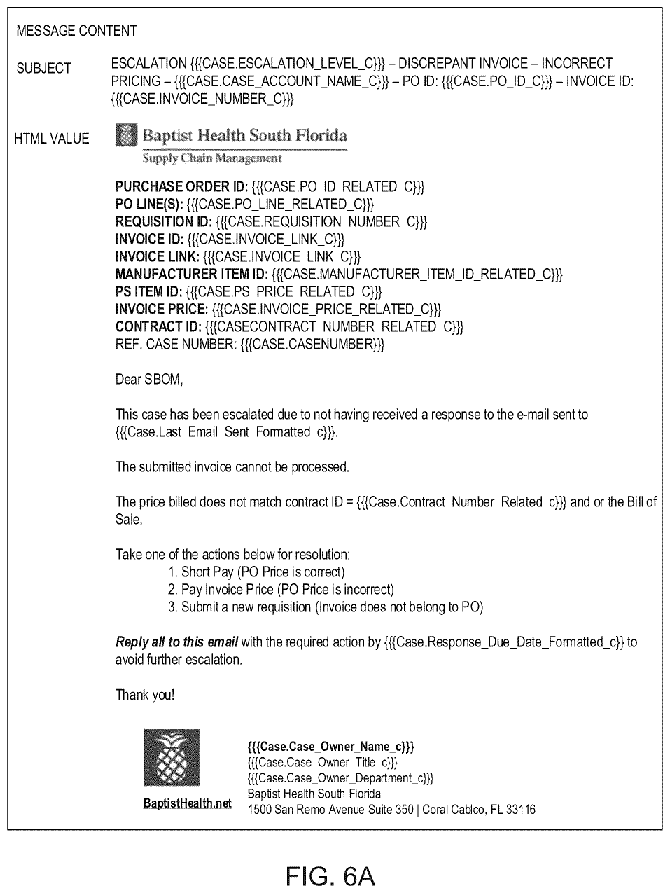

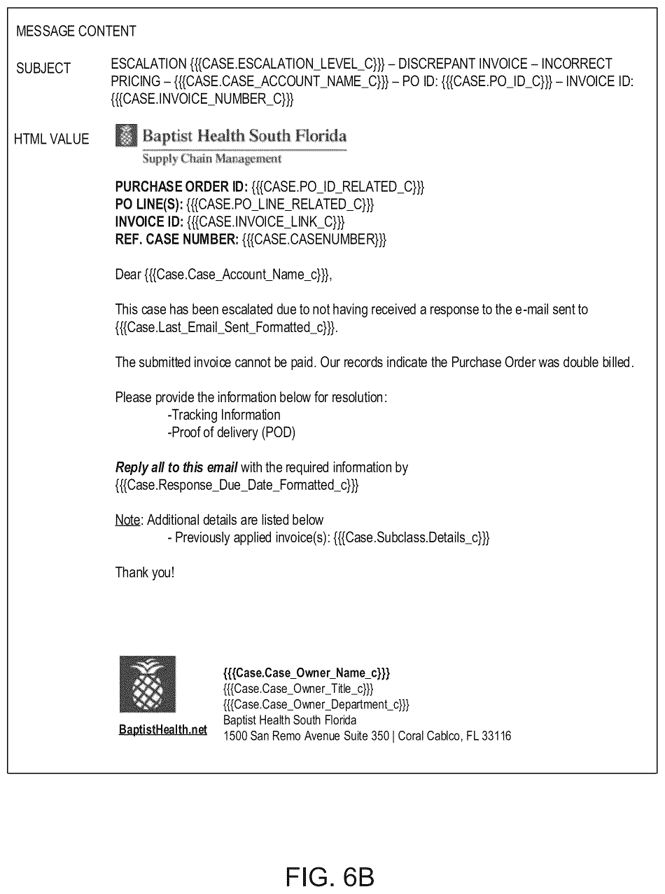

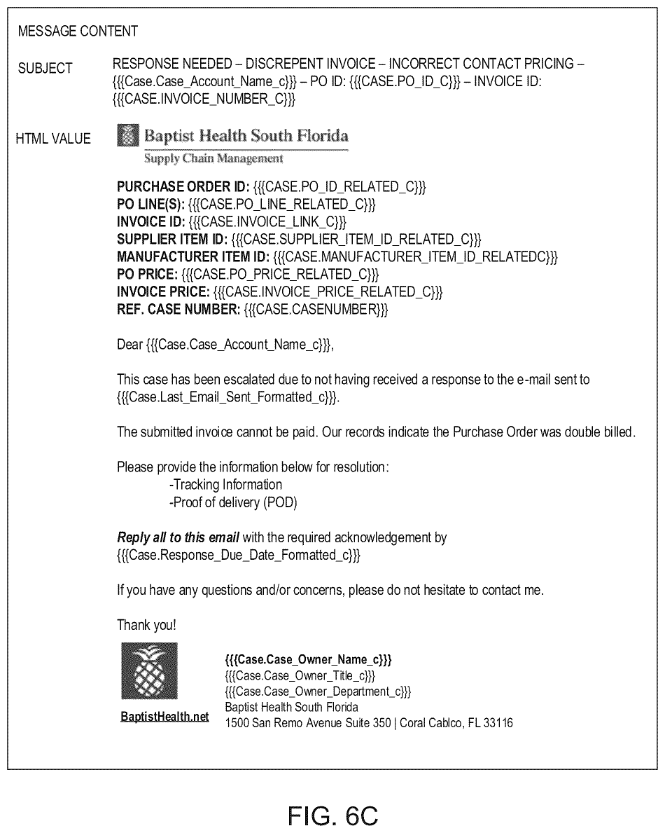

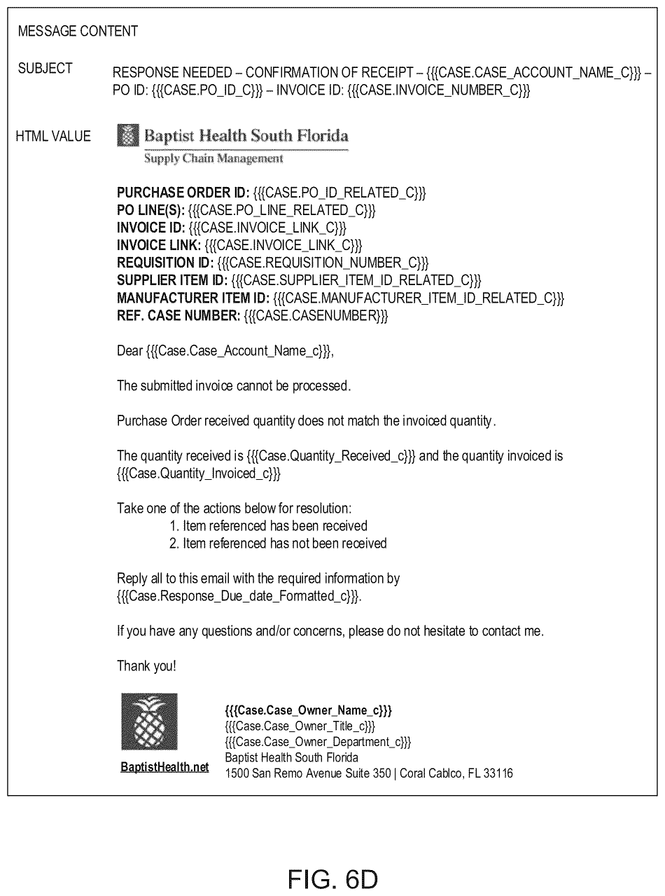

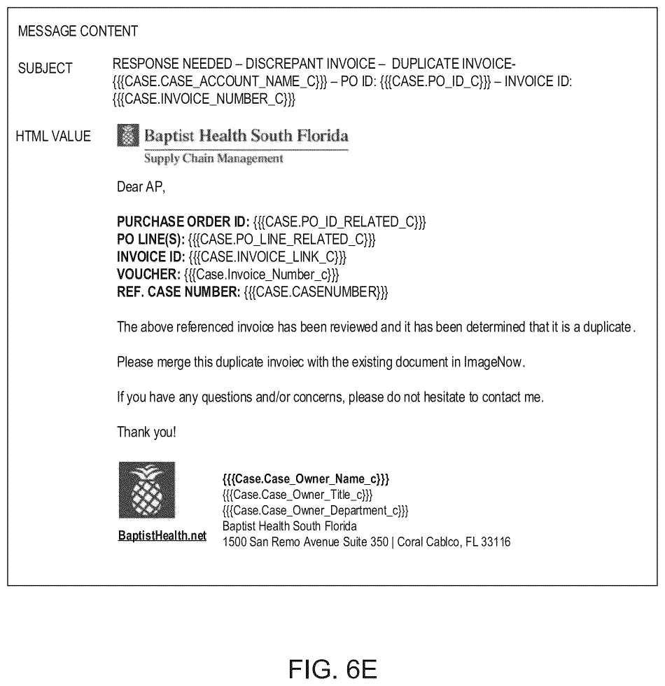

With reference to FIGS. 6A-6E, FIGS. 6A-6E are exemplary call-to-action illustrations for communicating in a supply chain according to non-limiting embodiments. For example, C2C prediction engine 102 notification with a call-to-action statement to recipient for prompting a user to act on an aspect of a match exception.

In some non-limiting embodiments or aspects, managing invoice discrepancies includes an automated workflow that ensures accurate and timely case creation, resolution, and communication. This system operates through daily integration data files, where new rows of data trigger the creation of corresponding cases. All unresolved invoice discrepancies are displayed within the interface until they are resolved, and their presence in the interface corresponds to their availability in the integration data files. Rules automatically assign cases during their creation, and cases are closed when the associated invoice discrepancies have been resolved and are no longer present in the integration data files.

In some non-limiting embodiments or aspects, the engines determine the appropriate email template for outbound communication. This process initiates an automatic outbound case email that is directed to the relevant recipient(s). If a case lacks sufficient contact information, the automatic email transmission will fail. In such cases, the user is notified, the automatic email sent field remains unchecked, and the Error Message field is populated with relevant error details.

In some non-limiting embodiments or aspects, responding to inbound emails activate changes in case status, with a logged inbound email response causing the case status to transition to “pending agent review.” An email notification of this change is sent to the case owner. As match exceptions are resolved, salesforce automatically defaults the resolution status if not already provided by the case owner. However, end users are required to manually update this status, accompanied by a resolution comment. In accordance with predefined timeframes, cases are automatically escalated, and corresponding emails are sent to the case owner's leader. Escalation takes place when a specified number of days pass since the last email requiring a response was recorded in the case. This process results in the system updating relevant case fields pertaining to the escalation.

In some non-limiting embodiments or aspects, intelligent responses enhance communication by incorporating action buttons into case-related emails. These action buttons allow recipients to respond without directly replying to the email. For instance, a price discrepancy email could contain action buttons like “will correct invoice to use PO price” and “researching price discrepancy.” To safeguard accuracy, out-of-office responses are identified and handled separately, thus excluding them from valid responses.

In some non-limiting embodiments or aspects, escalations are made when outgoing emails marked with a response requirement do not receive timely responses. Escalation levels progress based on the date of the last outgoing email that necessitated a response. Email notifications are sent to the leader of the user at the previous escalation level, and case details are updated to reflect pertinent escalation information upon successful escalation. Additionally, Agent Super User profiles possess the ability to edit escalation timeframes for optimal case management.

Although the disclosed subject matter has been described in detail for the purpose of illustration based on what is currently considered to be the most practical and preferred embodiments or aspects, it is to be understood that such detail is solely for that purpose and that the disclosed subject matter is not limited to the disclosed embodiments or aspects, but, on the contrary, is intended to cover modifications and equivalent arrangements that are within the spirit and scope of the appended claims. For example, it is to be understood that the presently disclosed subject matter contemplates that, to the extent possible, one or more features of any embodiment can be combined with one or more features of any other embodiment.

What is claimed is:

1. A computer-implemented method, comprising:
providing a plurality of interacting pipelines for sourcing a concept to a contract, including a concept pipeline and a contract pipeline;
initiating the concept pipeline to generate activities for guiding organizational users to determine sourcing details associated with an organizational opportunity or need;
initiating the contract pipeline to generate activities capable of defining one or more terms, conditions, or legal requirements of the contract, for an acquisition of goods, services, or products related to the organizational opportunity or requirement; and
synchronizing the plurality of interacting pipelines based on a trigger.

2. The computer-implemented method of claim 1, wherein synchronizing the plurality of interacting pipelines based on the trigger further comprises:
detecting the trigger;
in response to the trigger, activating a signal to initiate one or more activities in the contract pipeline; or
in response to the trigger, activating a signal to initiate one or more activities in the contract pipeline.

3. The computer-implemented method of claim 2, wherein the trigger occurs at a stage in the concept pipeline to ensure that activities associated with development of the concept align with development of contract terms or requirements, and includes at least one of:
a transition trigger, wherein the concept progresses to a point where a formal contract is needed to formalize an agreement between parties;
an awards trigger, wherein one or more vendors are awarded the contract;
a decision trigger, wherein a sourcing decision is generated;
a contract trigger, wherein it is determined that a formal contract is necessary; or
a communication trigger, wherein synchronization between the plurality of interacting pipelines includes communication of one or more critical details, requirements, or information related to a procurement decision, a selected vendor, one or more terms, or one or more conditions.

4. The computer-implemented method of claim 1, wherein information gathered by the concept pipeline, includes at least one of supplier evaluations, vendor selections, or procurement requirements, is transferred to the contract pipeline for drafting and negotiation.

5. The computer-implemented method of claim 1, wherein the concept pipeline and the contract pipeline run concurrently while at least one activation is made between the interacting pipelines to expedite a procurement.

6. The computer-implemented method of claim 1, wherein at least one activation is made between the interacting pipelines to expedite a procurement comprising at least one of:
identifying a need for a conceptual product or service;
creating a request for the conceptual product or service; or
obtaining one or more approvals that are required within the concept pipeline; and
wherein the contract pipeline comprises:
approving a requisition,
contract drafting, or
contract award.

7. The computer-implemented method of claim 1, further comprising:
providing a concept to contract (C2C) prediction engine for generating scores;
scoring, by the C2C prediction engine, one or more concepts as part of an assessment process to streamline decision-making and provide a quantitative measurement of the concept; and
prioritizing the one or more concepts based on a score for at least one of a viability of a concept, an alignment of a concept with at least one organizational goal, or a potential impact of a concept, and each score provides a quantitative measure to compare different concepts and to guide decision-makers in selecting a concept to proceed.

8. The computer-implemented method of claim 7, further comprising:
obtaining a set of evaluation criteria and key performance indicators (KPIs) that align with one or more objectives related to factors like cost-effectiveness, strategic alignment, feasibility, and potential impact;
assigning each criterion from the set of evaluation criteria a weight to reflect its relative importance, wherein financial viability might be weighted more heavily than other criteria and a scores weighting reflects a priority to the at least one organization goal;
assessing one or more concepts against each criterion;
assigning a plurality of numerical scores related to an alignment of the concept for each criterion;
normalizing the plurality of numerical scores to ensure that different criterion are on a common scale; and
generating a total concept score comprising each of the plurality of numerical scores to quantify an overall quality of the concept.

9. The computer-implemented method of claim 8, wherein each score reduces bias and subjectivity assessing one or more concepts against each criterion by providing an objective basis for comparing different ideas or proposals related to each concept,
wherein the total concept score allows decision-makers to prioritize concepts with higher scores are considered more promising and can be fast-tracked for further development,
wherein resources are directed to concepts with a greatest potential for success to prevent resources to limit over allocation of resource,
wherein concepts are evaluated against predefined criteria to identify potential risks and challenges and take appropriate actions to mitigate these risks or select alternative concepts,
wherein a scoring process ensures that selected concepts align with an organization's strategic goals and priorities;
wherein concepts that score high move through the plurality of the interacting pipelines more quickly than those that score lower for a streamlined execution of initiatives; and
wherein a scoring system provides transparency to stakeholders, providing insight into certain concepts that are chosen or rejected to enhance buy-in or support for selected concepts.

10. A system, comprising:
a memory; and
at least one processor coupled to the memory and configured to:
provide a plurality of interacting pipelines for sourcing a concept to a contract, including a concept pipeline and a contract pipeline;
initiate the concept pipeline to generate activities for guiding organizational users to determine sourcing details associated with an organizational opportunity or need;
initiate the contract pipeline to generate activities capable of defining one or more terms, conditions, or legal requirements of the contract, for an acquisition of goods, services, or products related to the organizational opportunity or requirement; and
synchronize the plurality of interacting pipelines based on a trigger.

11. The system of claim 10, wherein synchronizing the plurality of interacting pipelines based on the trigger further comprises configuring the at least one processor to:
detecting a trigger;
in response to the trigger, activating a signal to initiate one or more activities in the contract pipeline; or
in response to the trigger, activating a signal to initiate one or more activities in the contract pipeline.

12. The system of claim 11, wherein the trigger occurs at a stage in the concept pipeline to ensure that activities associated with development of the concept align with development of contract terms or requirements, and includes at least one of:
a transition trigger, wherein the concept progresses to a point where a formal contract is needed to formalize an agreement between parties;
an awards trigger, wherein one or more vendors are awarded the contract;
a decision trigger, wherein a sourcing decision is generated;
a contract trigger, wherein it is determined that a formal contract is necessary; or
a communication trigger, wherein synchronization between the plurality of interacting pipelines includes communication of one or more critical details, requirements, or information related to a procurement decision, a selected vendor, one or more terms, or one or more conditions.

13. The system of claim 11, wherein information gathered by the concept pipeline, includes at least one of supplier evaluations, vendor selections, or procurement requirements, is transferred to the contract pipeline for drafting and negotiation.

14. The system of claim 11, wherein the concept pipeline and the contract pipeline run concurrently while at least one activation is made between the interacting pipelines to expedite a procurement.

15. The system of claim 11, wherein at least one activation is made between the interacting pipelines to expedite a procurement comprising at least one of:
identifying a need for a conceptual product or service;
creating a request for the conceptual product or service; or
obtaining one or more approvals that are required within the concept pipeline; and
wherein the contract pipeline comprises:
approving a requisition,
contract drafting, or
contract award.

16. The system of claim 10, wherein the at least one processor to is configured to:
providing a concept to contract (C2C) prediction engine for generating scores;
scoring, by the C2C prediction engine, one or more concepts as part of an assessment process to streamline decision-making and provide a quantitative measurement of the concept; and
prioritizing the one or more concepts based on a score for at least one of a viability of a concept, an alignment of a concept with at least one organizational goal, or a potential impact of a concept, and each score provides a quantitative measure to compare different concepts and to guide decision-makers in selecting a concept to proceed.

17. The system of claim 10 wherein the at least one processor is configured to:
obtaining a set of evaluation criteria and key performance indicators (KPIs) that align with one or more objectives related to factors like cost-effectiveness, strategic alignment, feasibility, and potential impact;
assigning each criterion from the set of evaluation criteria a weight to reflect its relative importance, wherein financial viability might be weighted more heavily than other criteria and a scores weighting reflects a priority to the at least one organization goal;
assessing one or more concepts against each criterion;
assigning a plurality of numerical scores related to an alignment of the concept for each criterion;
normalizing the plurality of numerical scores to ensure that different criterion are on a common scale; and
generating a total concept score comprising each of the plurality of numerical scores to quantify an overall quality of the concept,
wherein each score reduces bias and subjectivity assessing one or more concepts against each criterion by providing an objective basis for comparing different ideas or proposals related to each concept,
wherein the total concept score allows decision-makers to prioritize concepts with higher scores are considered more promising and can be fast-tracked for further development,
wherein resources are directed to concepts with a greatest potential for success to prevent resources to limit over allocation of resource,
wherein concepts are evaluated against predefined criteria to identify potential risks and challenges and take appropriate actions to mitigate these risks or select alternative concepts,
wherein a scoring process ensures that selected concepts align with an organization's strategic goals and priorities;
wherein concepts that score high move through the plurality of the interacting pipelines more quickly than those that score lower for a streamlined execution of initiatives; and
wherein a scoring system provides transparency to stakeholders, providing insight into certain concepts that are chosen or rejected to enhance buy-in or support for selected concepts.

18. A non-transitory computer-readable medium having instructions stored thereon that, when executed by at least one computing device, cause the at least one computing device to:
provide a plurality of interacting pipelines for sourcing a concept to a contract, including a concept pipeline and a contract pipeline;
initiate the concept pipeline to generate activities for guiding organizational users to determine sourcing details associated with an organizational opportunity or need;
initiate the contract pipeline to generate activities capable of defining one or more terms, conditions, or legal requirements of the contract, for an acquisition of goods, services, or products related to the organizational opportunity or requirement; and
synchronize the plurality of interacting pipelines based on a trigger.

19. The non-transitory computer-readable medium of claim 18 wherein diagnosing at least one match exception, further causes the at least one computing device to:
detect a trigger;
in response to the trigger, activating a signal to initiate one or more activities in the contract pipeline; or
in response to the trigger, activating a signal to initiate one or more activities in the contract pipeline.

20. The non-transitory computer-readable medium of claim 19, wherein diagnosing at least one match exception, further includes:
a transition trigger, wherein the concept progresses to a point where a formal contract is needed to formalize an agreement between the parties;
an awards trigger, wherein one or more vendors are awarded the contract;
a decision trigger, wherein a sourcing decision is generated;
a contract trigger, wherein it is determined that a formal contract is necessary; or
a communication trigger, wherein synchronization between the plurality of interacting pipelines includes communication of one or more critical details, requirements, or information related to a procurement decision, a selected vendor, one or more terms, or one or more conditions.
